(19) United States
(12) Patent Application Publication
(10) Pub. No.: US 2022/0056228 A1
(43) Pub. Date: Feb. 24, 2022

(54) HARDCOAT FILM AND ARTICLE AND IMAGE DISPLAY DEVICE HAVING HARDCOAT FILM

(71) Applicant: FUJIFILM Corporation, Tokyo (JP)

(72) Inventors: Nobuyuki AKUTAGAWA, Kanagawa (JP); Ayako MATSUMOTO, Kanagawa (JP); Yuta FUKUSHIMA, Kanagawa (JP); Akio TAMURA, Kanagawa (JP); Tetsu KITAMURA, Kanagawa (JP); Yuzo NAGATA, Kanagawa (JP)

(73) Assignee: FUJIFILM Corporation, Tokyo (JP)

(21) Appl. No.: 17/521,025

(22) Filed: Nov. 8, 2021

Related U.S. Application Data
(63) Continuation of application No. PCT/JP2020/016639, filed on Apr. 15, 2020.

(30) Foreign Application Priority Data
May 17, 2019 (JP) 2019-093793

(51) Int. Cl. C08J 7/04; C09D 183/06; C09D 183/08; G02B 1/14

(52) U.S. Cl. CPC C08J 7/042; C09D 183/06; C09D 183/08; C08J 2383/08; C08J 2379/08; C08J 2377/00; C08J 2383/07; G02B 1/14

(57) ABSTRACT

A hardcoat film includes: a substrate; and a hardcoat layer, in which the hardcoat film satisfies the following Formulas (i) and (ii), (i) E′_{(0.4)HC}×d_{HC}≥8,000 MPa·μm, (ii) E′_{(4)HC}×d_{HC}≤4,000 MPa·μm, E′_{(0.4)HC} is an elastic modulus of the hardcoat layer obtained in a case where an elongation rate is 0.4%, E′_{(4)HC} is an elastic modulus of the hardcoat layer obtained in a case where an elongation rate is 4%, and d_{HC} is a film thickness of the hardcoat layer.

### CROSS REFERENCE TO RELATED APPLICATION

This is a continuation of International Application No. PCT/JP2020/016639 filed on Apr. 15, 2020, and claims priority from Japanese Patent Application No. 2019-093793 filed on May 17, 2019, the entire disclosures of which are incorporated herein by reference.

### BACKGROUND OF THE INVENTION

### 1. Field of the Invention

The present invention relates to a hardcoat film and an article and an image display device that have the hardcoat film.

### 2. Description of the Related Art

For image display devices such as a display device using a cathode ray tube (CRT), a plasma display panel (PDP), an electroluminescent display (ELD), a vacuum fluorescent display (VFD), a field emission display (FED), and a liquid crystal display (LCD), in order to prevent the display surface from being scratched, it is preferable to provide a laminate (hardcoat film) having a hardcoat layer on a substrate.

For example, JP2018-83915A describes a hardcoat film having a hardcoat layer that is on a substrate and consists of a cured product of a curable composition containing a cationically curable silicone resin and a leveling agent.

### SUMMARY OF THE INVENTION

In recent years, for example, for smartphones and the like, there has been an increasing need for ultra-thin flexible displays. Accordingly, there has been a strong demand for a hardcoat film that satisfies both the hardness and resistance to repeated folding (properties by which the hardcoat film does not crack even being repeatedly folded). Particularly, in a case where a hardcoat film is folded with a substrate facing inwards (hardcoat layer facing outwards), the hardcoat layer easily cracks, which is a technical problem very difficult to solve.

As a result of examination, the inventors of the present invention have found that the hardcoat film described in JP2018-83915A cannot simultaneously satisfy hardness and resistance to repeated folding.

An object of the present invention is to provide a hardcoat film which is excellent in hardness and resistance to repeated folding and an article and an image display device which comprise the hardcoat film.

As a result of intensive examination, the inventors of the present invention have found that the above object can be achieved by the following means.

<1>

A hardcoat film having a substrate and a hardcoat layer,

in which the hardcoat film satisfies the following Formulas (i) and (ii).

E′_{(0.4)HC}×d_{HC}≥8,000 MPa·μm (i)

E′_{(4)HC}×d_{HC}≤4,000 MPa·μm (ii)

E′_{(0.4)HC} is an elastic modulus of the hardcoat layer obtained in a case where an elongation rate is 0.4%,

E′_{(4)HC} is an elastic modulus of the hardcoat layer obtained in a case where an elongation rate is 4%, and

d_{HC} is a film thickness of the hardcoat layer.

<2>

A hardcoat film having a substrate and a hardcoat layer with an anti-scratch layer,

in which the hardcoat layer with an anti-scratch layer has a hardcoat layer and an anti-scratch layer, the hardcoat layer is closer to the substrate than the anti-scratch layer, and

the hardcoat film satisfies the following Formulas (iii) and (iv).

E′_{(0.4)RHC}×d_{RHC}≥8,000 MPa·μm (iii)

E′_{(4)RHC}×d_{RHC}≤4,000 MPa·μm (iv)

E′_{(0.4)RHC} is an elastic modulus of the hardcoat layer with an anti-scratch layer obtained in a case where an elongation rate is 0.4%,

E′_{(4)RHC} is an elastic modulus of the hardcoat layer with an anti-scratch layer obtained in a case where an elongation rate is 4%, and

d_{RHC} is a film thickness of the hardcoat layer with an anti-scratch layer.

<3>

The hardcoat film described in <1> or <2>, in which the substrate satisfies the following Formula (vi).

100,000 MPa·μm≤E′_{(0.4)S}×d_{S}≤520,000 MPa·μm (vi)

E′_{(0.4)S} is an elastic modulus of the substrate obtained in a case where an elongation rate is 0.4%, and

d_{S} is a film thickness of the substrate.

<4>

The hardcoat film described in any one of <1> to <3>, in which the hardcoat layer contains a cured product of a composition for forming a hardcoat layer containing a polyorganosilsesquioxane.

<5>

The hardcoat film described in <4>, in which the polyorganosilsesquioxane contains a constitutional unit (S1) that has a group containing a hydrogen atom capable of forming a hydrogen bond and a constitutional unit (S2) that is different from the constitutional unit (S1) and has a crosslinkable group.

<6>

The hardcoat film described in <5>, in which the group containing a hydrogen atom capable of forming a hydrogen bond that the constitutional unit (S1) has is at least one group selected from an amide group, a urethane group, or a urea group.

<7>

The hardcoat film described in <5> or <6>, in which the constitutional unit (S1) has a (meth)acryloyloxy group or a (meth)acrylamide group.

<8>

The hardcoat film described in any one of <5> to <7>, in which the crosslinkable group that the constitutional unit (S2) has is a (meth)acrylamide group.

<9>

The hardcoat film described in any one of <5> to <8>, in which a weight-average molecular weight of the polyorganosilsesquioxane is 10,000 to 1,000,000.

<10>

The hardcoat film described in any one of <1> to <9>, in which the film thickness of the hardcoat layer is 2 to 14 μm.

<11>

The hardcoat film described in any one of <1> to <10>, in which a film thickness of the substrate is 15 to 80 μm.

<12>

The hardcoat film described in any one of <1> to <11>, in which the substrate contains at least one polymer selected from an imide-based polymer or an aramid-based polymer.

<13>

An article comprising the hardcoat film described in any one of <1> to <12>.

<14>

An image display device comprising the hardcoat film described in any one of <1> to <12> as a surface protection film.

According to an aspect of the present invention, it is possible to provide a hardcoat film which is excellent in hardness and resistance to repeated folding and an article and an image display device which comprise the hardcoat film.

### DESCRIPTION OF THE PREFERRED EMBODIMENTS

Hereinafter, embodiments of the present invention will be specifically described, but the present invention is not limited thereto. In the present specification, in a case where numerical values represent a value of physical properties, a value of characteristics, and the like, the description of “(numerical value 1) to (numerical value 2)” means “(numerical value 1) or more and (numerical value 2) or less”. In addition, in the present specification, the description of “(meth)acrylate” means “at least one of acrylate or methacrylate”. The same shall be applied to “(meth)acrylic acid”, “(meth)acryloyl”, “(meth)acrylamide”, “(meth)acryloyloxy”, and the like.

[Hardcoat Film]

The hardcoat film according to an embodiment of the present invention has at least a substrate and a hardcoat layer (hardcoat layer provided on the substrate).

Although the hardcoat film of the present invention is required to have a hardcoat layer, the hardcoat film may have a functional layer other than the hardcoat layer as will be described later. Particularly, for example, in a case where a hardcoat film is to be disposed on the surface of a display, and it is desired to add scratch resistance in this case, it is preferable to provide the anti-scratch layer.

Hereinafter, an aspect in which the hardcoat film has at least a hardcoat layer will be described as a first aspect, and an aspect in which the hardcoat film has at least a hardcoat layer and an anti-scratch layer will be described as a second aspect.

A preferred aspect (first aspect) of the hardcoat film according to an embodiment of the present invention is

a hardcoat film which has a substrate and a hardcoat layer, and

satisfies Formulas (i) and (ii).

E′_{(0.4)HC}×d_{HC}≥8,000 MPa·μm (i)

E′_{(4)HC}×d_{HC}≤4,000 MPa·μm (ii)

E′_{(0.4)HC} is an elastic modulus of the hardcoat layer obtained in a case where an elongation rate is 0.4%,

E′_{(4)HC} is an elastic modulus of the hardcoat layer obtained in a case where an elongation rate is 4%, and

d_{HC} is a film thickness of the hardcoat layer.

The detailed mechanism through which the hardcoat film according to an embodiment of the present invention achieves the aforementioned object has not been completely clarified. According to the inventors of the present invention, the mechanism is assumed to be as below.

That is, in terms of physical properties. “E′_{(0.4)HC}×d_{HC}” and “E′_{(4)HC}×d_{HC}” in Formulas (i) and (ii) can be considered to show the force applied to the hardcoat layer at the respective elongation rates as will be described later (X). Presumably, satisfying Formula (ii) may imply that because substantially no tensile stress is applied to the hardcoat layer in a case where the hardcoat layer is relatively elongated (in a case where the elongation rate is 4%), defects such as cracks are unlikely to occur in the hardcoat layer. In a case where a typical form of hardcoat film in Examples which will be described later is bent, a difference in elongation of about 2% to 5% is often caused between the length of the outside and the length of the central portion. Therefore, it is considered that an elastic modulus obtained in a case where an elongation rate is 4% may be strongly correlated with the resistance to repeated folding.

Meanwhile, pencil hardness greatly depends on the initial indentation elastic modulus, and the indentation elastic modulus is correlated with tensile elastic modulus unless there is anisotropy. Therefore, presumably, unless the initial tensile elastic modulus is high, high pencil hardness could not be imparted. Presumably, in the present invention, satisfying Formula (i) may imply that the hardcoat layer has a high elastic modulus in the initial tensile mode (in which an elongation rate is 0.4%), and the hardcoat film may exhibit high pencil hardness accordingly.

※: Generally, stress and tensile elastic modulus are represented by the following formulas.

Stress(σ)=force(f)/cross-sectional area(A₀)

Tensile elastic modulus(E)=stress(σ)/strain(ε)

Here, considering the stress applied to the hardcoat layer underconstant strain (c), based on the above formulas, a force (f_{HC}) applied to the hardcoat layer is equal to the product of a tensile elastic modulus (E_{HC}) of the hardcoat layer and the cross-sectional area (A₀).

Force applied to hardcoat layer under constant strain(f_{HC})=tensile elastic modulus of hardcoat layer(E_{HC})×cross-sectional area(A₀)

The cross-sectional area (A₀) is determined by length×width×film thickness of a sample to be pulled. Because the length and width are constant, the cross-sectional area (A₀) is proportional to the film thickness.

Therefore, the following equation is derived.

Force applied to hardcoat layer under constant strain(f_{HC})=tensile elastic modulus of hardcoat layer(E_{HC})×film thickness of hardcoat layer(d_{HC})

(Elastic Modulus of Hardcoat Layer)

The elastic modulus (tensile elastic modulus) of the hardcoat layer in the present invention is calculated using the result of a tensile test on the hardcoat film (laminate having a substrate and the hardcoat layer) and the result of a tensile test on the substrate.

More specifically, a tensile test is performed on each of the hardcoat film and the substrate, and the relationship between elongation and load is measured for each of the hardcoat film and the substrate (a load-elongation curve (SS curve) is obtained by plotting load on the ordinate and plotting elongation on the abscissa). Then, from the difference between the load applied to the hardcoat film at each elongation and the load applied to the substrate at each elongation, the load applied only to the hardcoat layer is calculated.

Each of the hardcoat film and substrate samples subjected to the tensile test has a size of 120 mm (length)×10 mm (width). The sample is left to stand for 1 hour or longer in an environment at a temperature of 25° C. and a relative humidity of 60% and then pulled using a tensile tester, and the relationship between elongation and load is measured.

E′_{(0.4)HC} can be determined by the following procedures (1), (2), and (3).

(1) The difference between a stress (load÷cross-sectional area) applied in a case where the elongation rate of the hardcoat film is 0.4% and a stress (load÷cross-sectional area) applied in a case where the elongation rate of the substrate is 0.4% is calculated (stress difference A).

(2) The difference between a stress (load÷cross-sectional area) applied in a case where the elongation rate of the hardcoat film is 0.2% and a stress (load÷cross-sectional area) applied in a case where the elongation rate of the substrate is 0.2% is calculated (stress difference B).

(3) The difference between the stress difference A and the stress difference B is divided by the difference in the elongation rate (that is, 0.002), thereby calculating E′_{(0.4)HC}.

E′_{(4)HC} can be determined by the following procedures (4), (5), and (6).

(4) The difference between a stress (load÷cross-sectional area) applied in a case where the elongation rate of the hardcoat film is 4.0% and a stress (load÷cross-sectional area) applied in a case where the elongation rate of the substrate is 4.0% is calculated (stress difference C).

(5) The difference between a stress (load÷cross-sectional area) applied in a case where the elongation rate of the hardcoat film is 3.8% and a stress (load÷cross-sectional area) applied in a case where the elongation rate of the substrate is 3.8% is calculated (stress difference D).

(6) The difference between the stress difference C and the stress difference D is divided by the difference in the elongation rate (that is, 0.002), thereby calculating E′_{(4)HC}.

In a case where the length of a test piece (gauge length) is L₀ before the tensile test and then becomes L₁ during the tensile test in which the test piece is pulled under a predetermined load, the elongation rate (strain) is calculated by dividing an elongation amount (L₁−L₀) by L₀. Specifically, the elongation rate is represented by Equation (N).

Elongation rate (%)={(L₁−L₀)/L₀}×100 (N)

L₀ is the gauge length before the tensile test (initial gauge length), and L₁ is the gauge length during the tensile test.

E′_{(0.4)HC}×d_{HC} is 8,000 MPa·μm or more. From the viewpoint of hardness, E′_{(0.4)HC}×d_{HC} is preferably 9,000 MPa·μm or more, more preferably 12,000 MPa·μm or more, and even more preferably 27,000 MPa·μm or more.

The upper limit of E′_{(0.4)HC}×d_{HC} is not particularly limited. For example, from the viewpoint of thickness, the upper limit is preferably 50,000 MPa·μm or less, more preferably 40,000 MPa·μm or less, and even more preferably 30,000 MPa·μm or less.

1 MPa equals 10⁶ Pa.

E′_{(4)HC}×d_{HC} is 4,000 MPa·μm or less. From the viewpoint of resistance to repeated folding, E′_{(4)HC}×d_{HC} is preferably 2,500 MPa·μm or less, more preferably 1,300 MPa·μm or less, and even more preferably 1,000 MPa·μm or less.

The lower limit of E′_{(4)HC}×d_{HC} is not particularly limited. For example, the lower limit is preferably 300 MPa·μm or more, more preferably 350 MPa·μm or more, and even more preferably 450 MPa·μm or more.

(Film Thickness of Hardcoat Layer)

The film thickness (d_{HC}) of the hardcoat layer is not particularly limited, but is preferably 0.5 to 30 μm, more preferably 1 to 25 μm, even more preferably 2 to 20 μm, particularly preferably 2 to 14 μm, and most preferably 2 to 10 μm.

The film thickness of the hardcoat layer is calculated by observing the cross section of the hardcoat film by using an optical microscope. The cross-sectional sample can be prepared by a microtome method using a cross section cutting device ultramicrotome, a cross section processing method using a focused ion beam (FIB) device, or the like.

There are no particular limitations on the specific method for causing the hard coat layer in the hardcoat film according to an embodiment of the present invention to satisfy Formulas (i) and (ii). Examples of such a method include appropriately selecting the material forming the hardcoat layer, appropriately selecting the film thickness of the hardcoat layer, and the like. Preferred aspects of the material forming the hardcoat layer will be described later.

In the hardcoat film according to an embodiment of the present invention, it is preferable that the substrate satisfy Formula (vi).

100,000 MPa·μm≤E′_{(0.4)S}×d_{S}≤520,000 MPa·μm (vi)

E′_{(0.4)S} is an elastic modulus of the substrate obtained in a case where an elongation rate is 0.4%, and

d_{S} is a film thickness of the substrate.

E′_{(0.4)S}×d_{S} is preferably 100,000 MPa·μm or more, more preferably 150,000 MPa·μm or more, even more preferably 200,000 MPa·μm or more, and particularly preferably 300,000 MPa·μm or more.

Furthermore. E′_{(0.4)S}×d_{S} is preferably 600,000 MPa·μm or less, more preferably 520,000 MPa·μm or less, even more preferably 500,000 MPa·μm or less, and particularly preferably 400,000 MPa·μm or less.

As described above, the elastic modulus of the substrate is calculated using the result of the tensile test on the substrate.

The substrate sample (test piece) subjected to the tensile test has a size of 120 mm (length)×10 mm (width). The sample is left to stand for 1 hour or more in an environment at a temperature of 25° C. and a relative humidity of 60% and then pulled using a tensile tester, and the relationship between elongation and load is measured.

E′_{(0.4)S} is calculated by dividing a difference between a stress (load÷cross-sectional area) applied in a case where the elongation rate is 0.4% and a stress (load÷cross-sectional area) applied in a case where the elongation rate is 0.2% by a difference in elongation rate (that is, 0.002).

(Thickness of Substrate)

The thickness (d_{S}) of the substrate is not particularly limited. d_{S} is preferably 100 μm or less, more preferably 80 μm or less, and most preferably 50 μm or less. In a case where the substrate has a small thickness, the difference in curvature between the front surface and the back surface of the folded substrate is reduced. Therefore, cracks and the like are unlikely to occur, and the substrate is unlikely to be broken even being folded plural times. On the other hand, from the viewpoint of ease of handling of the substrate, the thickness of the substrate is preferably 3 μm or more, more preferably 5 μm or more, and most preferably 15 μm or more. For example, in a preferred aspect, the thickness (d_{S}) of the substrate is 15 to 80 μm.

There are no particular limitations on the specific method for causing the substrate in the hardcoat film according to an embodiment of the present invention to satisfy Formula (vi). Examples of such a method include appropriately selecting the material forming the substrate, appropriately selecting the film thickness of the substrate, and the like. Preferred aspects of the material forming the substrate will be described later.

Although the hardcoat film according to an embodiment of the present invention is required to have a hardcoat layer on a substrate, the hardcoat film may additionally have functional layers other than the hardcoat layer.

The functional layers other than the hardcoat layer are not particularly limited, and examples thereof include an anti-scratch layer, a conductive layer, a barrier layer, an adhesive layer, an ultraviolet (UV) absorbing layer, an antifouling layer, and the like.

For example, the hardcoat film according to an embodiment of the present invention may be constituted with the following layers.
Substrate/hardcoat layer
Substrate/hardcoat layer/anti-scratch layer
Substrate/adhesive layer/hardcoat layer
Substrate/adhesive layer/hardcoat layer/anti-scratch layer
Substrate/conductive layer/hardcoat layer
Substrate/conductive layer/hardcoat layer/anti-scratch layer
Substrate/barrier layer/hardcoat layer
Substrate/barrier layer/hardcoat layer/anti-scratch layer
Substrate/UV absorbing layer/hardcoat layer
Substrate/UV absorbing layer/hardcoat layer/anti-scratch laver
Substrate/hardcoat layer/antifouling layer
Substrate/hardcoat layer/anti-scratch layer/antifouling layer

As described above, for example, in a preferred aspect, the hardcoat film according to an embodiment of the present invention has an anti-scratch layer on a hardcoat layer. As will be described later, it is preferable that the film thickness of the anti-scratch layer be smaller than that of the hardcoat layer. Therefore, a layer as a laminate of the hardcoat layer and the anti-scratch layer is also called a hardcoat layer with an anti-scratch layer.

That is, in a preferred aspect (second aspect), the hardcoat film according to an embodiment of the present invention has

a substrate and a hardcoat layer with an anti-scratch layer,

the hardcoat layer with an anti-scratch layer has a hardcoat layer and an anti-scratch layer, the hardcoat layer is closer to the substrate than the anti-scratch layer, and

the hardcoat film satisfies Formulas (iii) and (iv).

E′_{(0.4)RHC}×d_{RHC}≥8,000 MPa·μm (iii)

E′_{(4)RHC}×d_{RHC}≤4,000 MPa·μm (iv)

E′_{(0.4)RHC} is an elastic modulus of the hardcoat layer with an anti-scratch layer obtained in a case where an elongation rate is 0.4%,

E′_{(4)RHC} is an elastic modulus of the hardcoat layer with an anti-scratch layer obtained in a case where an elongation rate is 4%, and

d_{RHC} is a film thickness of the hardcoat layer with an anti-scratch layer.

The hardcoat film of the second aspect of the present invention is excellent not only in hardness and resistance to repeated folding but also in scratch resistance. The mechanism assumed to result in excellent hardness and excellent resistance to repeated folding is the same as the mechanism described in the first aspect.

(Elastic Modulus of Hardcoat Layer with Anti-Scratch Layer)

The elastic modulus of the hardcoat layer with an anti-scratch layer in the present invention is calculated using the result of a tensile test on the hardcoat film (laminate having a substrate and the hardcoat layer with an anti-scratch layer) and the result of a tensile test on the substrate.

The specific calculation method is the same as that described above.

E′_{(0.4)RHC} can be determined by the following procedures (7), (8), and (9).

(7) The difference between a stress (load÷cross-sectional area) applied in a case where the elongation rate of the hardcoat film is 0.4% and a stress (load÷cross-sectional area) applied in a case where the elongation rate of the substrate is 0.4% is calculated (stress difference E).

(8) The difference between a stress (load÷cross-sectional area) applied in a case where the elongation rate of the hardcoat film is 0.2% and a stress (load÷cross-sectional area) applied in a case where the elongation rate of the substrate is 0.2% is calculated (stress difference F).

(9) The difference between the stress difference E and the stress difference F is divided by the difference in the elongation rate (that is, 0.002), thereby calculating E′_{(0.4)RHC}.

E′_{(4)RHC} can be determined by the following procedures (10), (11), and (12).

(10) The difference between a stress (load÷cross-sectional area) applied in a case where the elongation rate of the hardcoat film is 4.0% and a stress (load÷cross-sectional area) applied in a case where the elongation rate of the substrate is 4.0% is calculated (stress difference G).

(11) The difference between a stress (load÷cross-sectional area) applied in a case where the elongation rate of the hardcoat film is 3.8% and a stress (load÷cross-sectional area) applied in a case where the elongation rate of the substrate is 3.8% is calculated (stress difference H).

(12) The difference between the stress difference G and the stress difference H is divided by the difference in the elongation rate (that is, 0.002), thereby calculating E′_{(4)RHC}.

E′_{(0.4)RHC}×d_{RHC} is 8,000 MPa·μm or more. From the viewpoint of hardness, E′_{(0.4)RHC}×d_{RHC} is preferably 9,000 MPa·μm or more, more preferably 12,000 MPa·μm or more, and even more preferably 27,000 MPa·μm or more.

The upper limit of E′_{(0.4)RHC}×d_{RHC} is not particularly limited. For example, from the viewpoint of thickness, the upper limit is preferably 50,000 MPa·μm or less, more preferably 40,000 MPa·μm or less, and even more preferably 30,000 MPa·μm or less.

E′_{(4)RHC}×d_{RHC} is 4.000 MPa·μm or less. From the viewpoint of resistance to repeated folding, E′_{(4)RHC}×d_{RHC} is preferably 2,500 MPa·μm or less, more preferably 1,300 MPa·μm or less, and even more preferably 1,000 MPa·μm or less.

The lower limit of E′_{(4)RHC}×d_{RHC} is not particularly limited. For example, the lower limit is preferably 300 MPa·μm or more, more preferably 350 MPa·μm or more, and even more preferably 450 MPa·μm or more.

(Film Thickness of Hardcoat Layer with Anti-Scratch Layer)

The film thickness (d_{RHC}) of the hardcoat laver with an anti-scratch laver is not particularly limited, but is preferably 0.5 to 30 μm, more preferably 1 to 25 μm, even more preferably 2 to 20 μm, particularly preferably 2 to 14 μm, and most preferably 2 to 10 μm.

The film thickness of the hardcoat layer with an anti-scratch layer is calculated by observing the cross section of the hardcoat film by using an optical microscope. The cross-sectional sample can be prepared by a microtome method using a cross section cutting device ultramicrotome, a cross section processing method using a focused ion beam (FIB) device, or the like.

(Film Thickness of Anti-Scratch Layer)

The film thickness of the anti-scratch layer is not particularly limited. From the viewpoint of resistance to repeated folding, the film thickness of the anti-scratch layer is preferably less than 3.0 μm, more preferably 0.1 to 2.0 μm, and even more preferably 0.1 to 1.0 μm.

The film thickness of the anti-scratch layer is calculated by observing the cross section of the hardcoat film by using an optical microscope. The cross-sectional sample can be prepared by a microtome method using a cross section cutting device ultramicrotome, a cross section processing method using a focused ion beam (FIB) device, or the like.

There are no particular limitations on the specific method for causing the hardcoat layer with an anti-scratch layer in the hardcoat film according to an embodiment of the present invention to satisfy Formulas (iii) and (iv). Examples of such a method include appropriately selecting the materials forming the hardcoat layer and the anti-scratch layer, appropriately selecting the film thickness of the hardcoat layer with an anti-scratch layer, and the like. Preferred aspects of the materials forming the hardcoat layer and the anti-scratch layer will be described later.

Preferred aspects of the substrate (preferably satisfying Formula (vi) and preferable ranges of E′_{(0.4)S}×d_{S} and film thickness) in the second aspect of the hardcoat film according to an embodiment of the present invention are the same as the preferred aspects of the substrate in the first aspect described above.

[Material of Hardcoat Layer]

Preferred aspects of the material of the hardcoat layer (material forming the hardcoat layer) in the hardcoat film according to an embodiment of the present invention, and the like will be described.

It is preferable that the hardcoat layer be formed by curing a composition for forming a hardcoat layer. That is, it is preferable that the hardcoat laver contain a cured product of the composition for forming a hardcoat layer.

It is preferable that the composition for forming a hardcoat layer contain at least polyorganosilsesquioxane. That is, it is preferable that the hardcoat layer contain a cured product of the composition for forming a hardcoat layer containing polyorganosilsesquioxane.

<Polyorganosilsesquioxane (a1) Having Group Containing Hydrogen Atom Capable of Forming Hydrogen Bond>

It is preferable that the composition for forming a hardcoat layer contain polyorganosilsesquioxane (a1) having a group containing a hydrogen atom capable of forming a hydrogen bond (also called “polyorganosilsesquioxane (a1)”).

(Group Containing Hydrogen Atom Capable of Forming Hydrogen Bond)

The polyorganosilsesquioxane (a1) has a group containing a hydrogen atom capable of forming a hydrogen bond. The hydrogen atom capable of forming a hydrogen bond is a hydrogen atom that is covalently bonded to an atom having high electronegativity, and can form a hydrogen bond with neighboring nitrogen, oxygen, and the like.

As the group containing a hydrogen atom capable of forming a hydrogen bond that the polyorganosilsesquioxane (a1) has, a generally known group containing a hydrogen atom capable of forming a hydrogen bond can be used. Such a group is preferably at least one group selected from an amide group, a urethane group, a urea group, or a hydroxyl group, and more preferably at least one group selected from an amide group, a urethane group, or a urea group.

In the present invention, an amide group is a divalent linking group represented by —NH—C(═O)—, a urethane group is a divalent linking group represented by —NH—C(═O)—O—, and a urea group is a divalent linking group represented by —NH—C(═O)—NH—.

(Crosslinkable Group)

It is preferable that the polyorganosilsesquioxane (a1) have a crosslinkable group.

The crosslinkable group is not particularly limited as long as it can form a covalent bond through a reaction, and examples thereof include a radically polymerizable crosslinkable group and a cationically polymerizable crosslinkable group.

As the radically polymerizable crosslinkable group, generally known radically polymerizable crosslinkable groups can be used. Examples of the radically polymerizable crosslinkable group include a polymerizable unsaturated group, and specific examples thereof include a vinyl group, an allyl group, a (meth)acryloyloxy group, a (meth)acrylamide group, and the like. Among these, a (meth)acryloyloxy group or a (meth)acrylamide group is preferable. Each of the above groups may have a substituent.

The (meth)acrylamide group exemplified as the crosslinkable group contains an amide group, and also corresponds to the group containing a hydrogen atom capable of forming a hydrogen bond.

As the cationically polymerizable crosslinkable group, generally known cationically polymerizable crosslinkable groups can be used. Specifically, examples thereof include an alicyclic ether group, a cyclic acetal group, a cyclic lactone group, a cyclic thioether group, a spiro-orthoester group, a vinyloxy group, and the like. As the cationically polymerizable group, an alicyclic ether group and a vinyloxy group are preferable, and an epoxy group and an oxetanyl group are particularly preferable. The epoxy group may be an alicyclic epoxy group (a group having a condensed ring structure of an epoxy group and an alicyclic group). Each of the above groups may have a substituent.

The crosslinkable group of the polyorganosilsesquioxane (a1) is preferably a radically polymerizable crosslinkable group, and is more preferably at least one group selected from a (meth)acryloyloxy group or a (meth)acrylamide group.

The polyorganosilsesquioxane (a1) may be a polymer consisting of only one monomer or a copolymer consisting of two or more monomers.

In a case where the polyorganosilsesquioxane (a1) is a polymer consisting of only one monomer, the monomer is preferably a monomer having a group containing a hydrogen atom capable of forming a hydrogen bond. In this case, the polyorganosilsesquioxane (a1) is preferably a polymer consisting of a constitutional unit (S1) having a group containing a hydrogen atom capable of forming a hydrogen bond.

In a case where the polyorganosilsesquioxane (a1) is a copolymer of two or more monomers, as the monomers, a monomer having a group containing a hydrogen atom capable of forming a hydrogen bond and a monomer having a crosslinkable group are preferable. In this case, it is preferable that the polyorganosilsesquioxane (a1) have the constitutional unit (S1) that has a group containing a hydrogen atom capable of forming hydrogen bond and a constitutional unit (S2) that is different from the constitutional unit (S1) and has a crosslinkable group. —Constitutional Unit (S1) Having Group Containing Hydrogen Atom Capable of Forming Hydrogen Bond—

The constitutional unit (S1) has a group containing a hydrogen atom capable of forming a hydrogen bond. The group containing a hydrogen atom capable of forming a hydrogen bond that the constitutional unit (S1) has is preferably at least one group selected from an amide group, a urethane group, a urea group, or a hydroxyl group, and more preferably at least one group selected from an amide group, a urethane group, or a urea group.

The constitutional unit (S1) may have at least one hydrogen atom capable of forming a hydrogen bond. The number of such hydrogen atoms in the constitutional unit (S1) is preferably 1 or 2.

The polyorganosilsesquioxane (a1) may have only one constitutional unit (S1) or two or more constitutional units (S1).

It is preferable that the constitutional unit (S1) additionally have a crosslinkable group. As the crosslinkable group, a radically polymerizable crosslinkable group is preferable, a vinyl group, an allyl group, a (meth)acryloyloxy group, or a (meth)acrylamide group is more preferable, a (meth)acryloyloxy group or a (meth)acrylamide group is even more preferable, and an acryloyloxy group or an acrylamide group is particularly preferable.

The constitutional unit (S1) is preferably a constitutional unit represented by General Formula (S1-1).

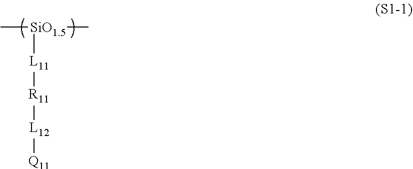

In General Formula (S1-1),

L₁₁ represents a substituted or unsubstituted alkylene group,

R₁₁ represents a single bond, —NH—, —O—, —C(═O)—, or a divalent linking group obtained by combining these.

L₁₂ represents a substituted or unsubstituted alkylene group, and

Q₁₁ represents a crosslinkable group.

Here, the constitutional unit represented by General Formula (S1-1) has at least one group containing a hydrogen atom capable of forming a hydrogen bond.

“SiO_{1.5}” in General Formula (S1-1) represents a structural portion composed of a siloxane bond (Si—O—Si) in the polyorganosilsesquioxane.

The polyorganosilsesquioxane is a network-type polymer or polyhedral cluster having a siloxane constitutional unit (silsesquioxane unit) derived from a hydrolyzable trifunctional silane compound, and can form a random structure, a ladder structure, a cage structure, and the like by a siloxane bond. In the present invention, although the structural portion represented by “SiO_{1.5}” may be any of the above structures, it is preferable that the structural portion contain many ladder structures. In a case where the ladder structure is formed, the deformation recovery of the hardcoat film can be excellently maintained. Whether the ladder structure is formed can be qualitatively determined by checking whether or not absorption occurs which results from Si—O—Si expansion/contraction unique to the ladder structure found at around 1,020 to 1,050 cm⁻¹ by Fourier Transform Infrared Spectroscopy (FT-IR).

In General Formula (S1-1), L₁₁ represents an alkylene group which is preferably an alkylene group having 1 to 10 carbon atoms. Examples thereof include a methylene group, a methyl methylene group, a dimethyl methylene group, an ethylene group an i-propylene group, a n-propylene group, a n-butylene group, a n-pentylene group, a n-hexylene group, a n-decylene group, and the like.

In a case where the alkylene group represented by L₁₁ has a substituent, examples of the substituent include a hydroxyl group, a carboxyl group, an alkoxy group, an aryl group, a heteroaryl group, a halogen atom, a nitro group, a cyano group, a silyl group, and the like.

L₁₁ is preferably an unsubstituted linear alkylene group having 2 to 4 carbon atoms, more preferably an ethylene group or a n-propylene group, and even more preferably a n-propylene group.

In General Formula (S1-1), R₁₁ represents a single bond, —NH—, —O—, —C(═O)—, or a divalent linking group obtained by combining these.

Examples of the divalent linking group obtained by combining —NH—, —O—, and —C(═O)— include *—NH—C(═O)—**, *—C(═O)—NH—**, *—NH—C(═O)—O—**, *—O—C(═O)—NH—**, —NH—C(═O)—NH—, *—C(═O)—O—**, *—O—C(═O)—**, and the like. * Represents a bond with L₁₁ in General Formula (S1-1), and ** represents a bond with L₁₂ in General Formula (S1-1).

R₁₁ is preferably —NH—C(═O)—NH—, *—NH—C(═O)—O—**, *—NH—C(═O)—**, or —O—, and more preferably —NH—C(═O)—NH—, *—NH—C(═O)—O—**, or *—NH—C(═O)—**.

In General Formula (S1-1), L₁₂ represents an alkylene group which is preferably an alkylene group having 1 to 10 carbon atoms. Examples thereof include a methylene group, a methyl methylene group, a dimethyl methylene group, an ethylene group an i-propylene group, a n-propylene group, a n-butylene group, a n-pentylene group, a n-hexylene group, a n-decylene group, and the like.

In a case where the alkylene group represented by L₁₂ has a substituent, examples of the substituent include a hydroxyl group, a carboxyl group, an alkoxy group, an aryl group, a heteroaryl group, a halogen atom, a nitro group, a cyano group, a silyl group, and the like.

L₁₂ is preferably a linear alkylene group having 1 to 3 carbon atoms, more preferably a methylene group, an ethylene group, a n-propylene group, or a 2-hydroxy-n-propylene group, and even more preferably a methylene group or an ethylene group.

In General Formula (S1-1), Q₁₁ represents a crosslinkable group. As the crosslinkable group, a radically polymerizable crosslinkable group is preferable, a vinyl group, an allyl group, a (meth)acryloyloxy group, or a (meth)acrylamide group is more preferable, a (meth)acryloyloxy group or a (meth)acrylamide group is even more preferable, and an acryloyloxy group or an acrylamide group is particularly preferable.

The constitutional unit represented by General Formula (S1-1) has at least one group containing a hydrogen atom capable of forming a hydrogen bond.

Examples of the group containing a hydrogen atom capable of forming a hydrogen bond include an amide group, a urethane group, a urea group, and a hydroxyl group.

It is preferable that the constitutional unit represented by General Formula (S1-1) contain one or two hydrogen atoms capable of forming a hydrogen bond.

It is preferable that the hydrogen atom capable of forming a hydrogen bond be incorporated into R₁₁ in General Formula (S1-1) as an amide group, a urethane group, or a urea group.

The constitutional unit represented by General Formula (S1-1) is preferably a constitutional unit represented by General Formula (S1-2).

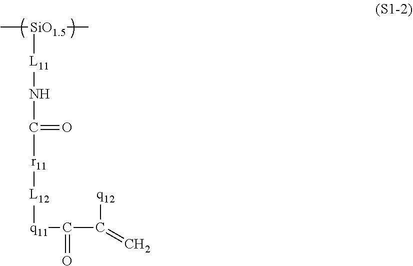

In General Formula (S1-2),

L₁₁ represents a substituted or unsubstituted alkylene group,

r₁₁ represents a single bond, —NH—, or —O—,

L₁₂ represents a substituted or unsubstituted alkylene group,

q₁₁ represents —NH— or —O—, and

q₁₂ represents a hydrogen atom or a methyl group.

“SiO_{1.5}” in General Formula (S1-2) represents a structural portion composed of a siloxane bond (Si—O—Si) in the polyorganosilsesquioxane.

In General Formula (S1-2), Lₙ represents a substituted or unsubstituted alkylene group. L₁₁ has the same definition as L₁₁ in General Formula (S1-1), and preferred examples thereof are also the same.

In General Formula (S1-2), L₁₂ represents a substituted or unsubstituted alkylene group. L₁₂ has the same definition as L₁₂ in General Formula (S1-1), and preferred examples thereof are also the same.

q₁₂ represents a hydrogen atom or a methyl group, and is preferably a hydrogen atom. —Constitutional Unit (S2) Having Crosslinkable Group—

The constitutional unit (S2) has a crosslinkable group. As the crosslinkable group, a radically polymerizable crosslinkable group is preferable, a vinyl group, an allyl group, a (meth)acryloyloxy group, or a (meth)acrylamide group is more preferable, a (meth)acryloyloxy group or a (meth)acrylamide group is even more preferable, a (meth)acrylamide group is particularly preferable, and an acrylamide group is most preferable.

The polyorganosilsesquioxane (a1) may have only one constitutional unit (S2) or two or more constitutional units (S2).

The constitutional unit (S2) is preferably a constitutional unit represented by General Formula (S2-1).

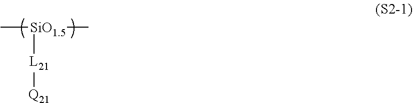

In General Formula (S2-1),

L₂₁ represents a substituted or unsubstituted alkylene group, and

Q₂₁ represents a crosslinkable group.

“SiO_{1.5}” in General Formula (S2-1) represents a structural portion composed of a siloxane bond (Si—O—Si) in the polyorganosilsesquioxane.

In General Formula (S2-1), L₂₁ represents an alkylene group which is preferably an alkylene group having 1 to 10 carbon atoms. Examples thereof include a methylene group, a methyl methylene group, a dimethyl methylene group, an ethylene group an i-propylene group, a n-propylene group, a n-butylene group, a n-pentylene group, a n-hexylene group, a n-decylene group, and the like.

In a case where the alkylene group represented by L₂₁ has a substituent, examples of the substituent include a hydroxyl group, a carboxyl group, an alkoxy group, an aryl group, a heteroaryl group, a halogen atom, a nitro group, a cyano group, a silyl group, and the like.

L₂₁ is preferably an unsubstituted linear alkylene group having 2 to 4 carbon atoms, more preferably an ethylene group or a n-propylene group, and even more preferably a n-propylene group.

In General Formula (S2-1), Q₂₁ represents a crosslinkable group. As the crosslinkable group, a radically polymerizable crosslinkable group is preferable, a vinyl group, an allyl group, a (meth)acryloyloxy group, or a (meth)acrylamide group is more preferable, and a (meth)acryloyloxy group or a (meth)acrylamide group is even more preferable.

The constitutional unit represented by General Formula (S2-1) is preferably a constitutional unit represented by General Formula (S2-2).

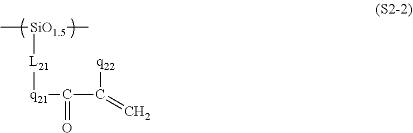

In General Formula (S2-2),

L₂₁ represents a substituted or unsubstituted alkylene group,

q₂₁ represents —NH— or —O—, and

q₂₂ represents a hydrogen atom or a methyl group.

“SiO_{1.5}” in General Formula (S2-2) represents a structural portion composed of a siloxane bond (Si—O—Si) in the polyorganosilsesquioxane.

In General Formula (S2-2). L₂₁ represents a substituted or unsubstituted alkylene group. L₂₁ has the same definition as L₂₁ in General Formula (S2-1), and preferred examples thereof are also the same.

q₂₁ represents —NH— or —O—, and is preferably —NH—.

q₂₂ represents a hydrogen atom or a methyl group, and is preferably a hydrogen atom.

The polyorganosilsesquioxane (a1) preferably contains a constitutional unit represented by General Formula (S1-1) and a constitutional unit represented by General Formula (S2-1), and more preferably contains a constitutional unit represented by General Formula (S1-2) and a constitutional unit represented by General Formula (S2-2).

In a case where the polyorganosilsesquioxane (a1) has the constitutional units (S1) and (S2), the molar ratio of the content of the constitutional unit (S1) to the total content of constitutional units is preferably more than 1 mol % and 90 mol % or less, more preferably 15 mol % or more and 75 mol % or less, and even more preferably 35 mol % or more and 65 mol % or less.

In a case where the polyorganosilsesquioxane (a1) has the constitutional units (S1) and (S2), the molar ratio of the content of the constitutional unit (S2) to the total content of constitutional units is preferably 15 mol % or more and 85 mol % or less, more preferably 30 mol % or more and 80 mol % or less, and even more preferably 35 mol % or more and 65 mol % or less.

As long as the effects of the present invention are not affected, the polyorganosilsesquioxane (a1) may have a constitutional unit (S3) in addition to the constitutional units (S1) and (S2). In the polyorganosilsesquioxane (a1), the molar ratio of the content of the constitutional unit (S3) to the total content of constitutional units is preferably 10 mol % or less, and more preferably 5 mol % or less. It is even more preferable that the polyorganosilsesquioxane (a1) do not contain the constitutional unit (S3).

In a case where the polyorganosilsesquioxane (a1) is a polymer consisting of only one monomer, the polyorganosilsesquioxane (a1) preferably has the constitutional unit (S1), more preferably has a constitutional unit represented by General Formula (S1-1), and even more preferably has a constitutional unit represented by General Formula (S1-2).

Specific examples of the polyorganosilsesquioxane (a1) will be shown below, but the present invention is not limited thereto. In the following structural formulas, “SiO_{1.5}” represents a silsesquioxane unit.

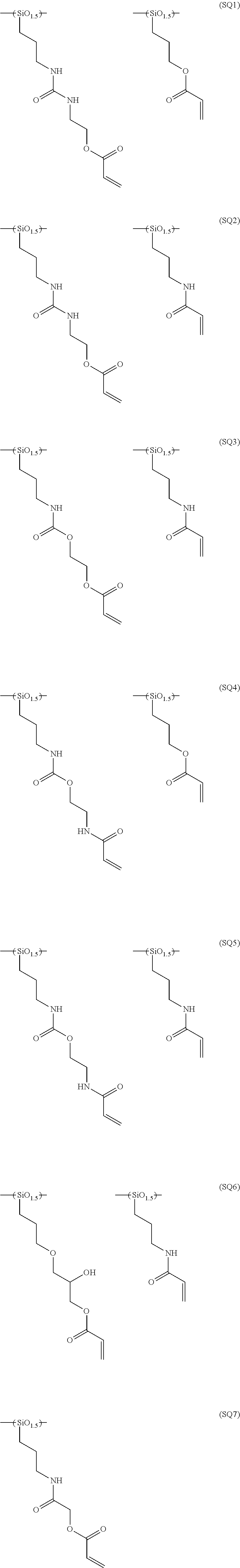

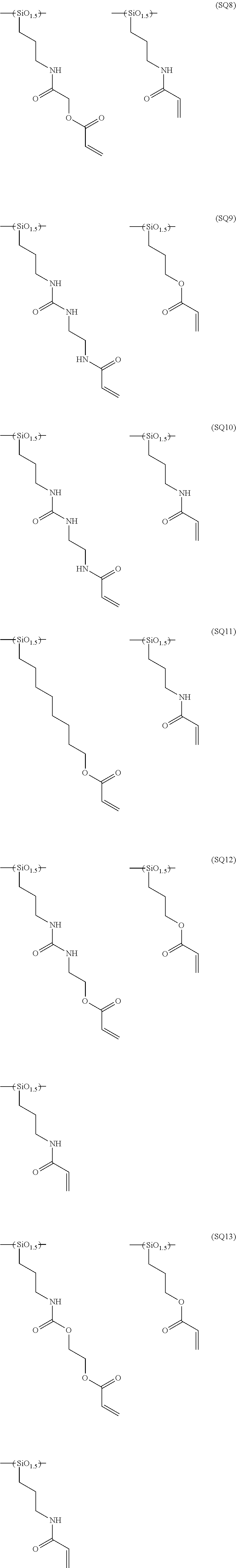

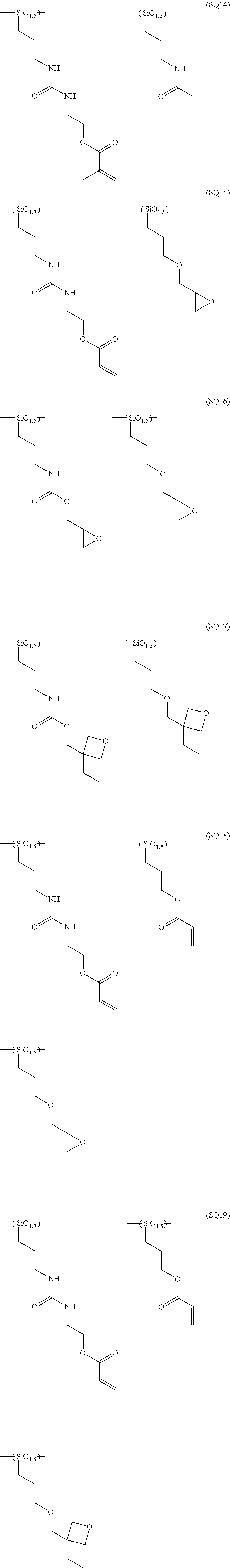

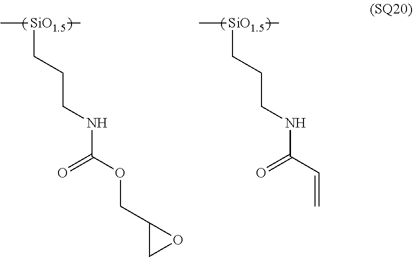

From the viewpoint of improving pencil hardness, the weight-average molecular weight (Mw) of the polyorganosilsesquioxane (a1) that is measured by gel permeation chromatography (GPC) and expressed in terms of standard polystyrene is preferably 5,000 to 1,000,000, more preferably 10,000 to 1,000,000, and even more preferably 10,000 to 100,000.

The molecular weight dispersity (Mw/Mn) of the polyorganosilsesquioxane (a1) that is measured by GPC and expressed in terms of standard polystyrene is, for example, 1.0 to 4.0, preferably 1.1 to 3.7, more preferably 1.2 to 3.0, and even more preferably 1.3 to 2.5. Mw represents weight-average molecular weight, and Mn represents number-average molecular weight.

The weight-average molecular weight and the molecular weight dispersity of the polyorganosilsesquioxane (a1) are measured using the following device under the following conditions.

Measurement device: trade name “LC-20AD” (manufactured by Shimadzu Corporation)

Columns: two Shodex KF-801 columns, KF-802, and KF-803 (manufactured by SHOWA DENKO K.K.)

Measurement temperature: 40° C.

Eluent: N-methylpyrrolidone (NMP), sample concentration of 0.1% to 0.2% by mass

Flow rate: 1 mL/min

Detector: UV-VIS detector (trade name “SPD-20A”, manufactured by Shimadzu Corporation)

Molecular weight: expressed in terms of standard polystyrene

<Method for Manufacturing Polyorganosilsesquioxane (a1)>

The method for manufacturing the polyorganosilsesquioxane (a1) is not particularly limited. The polyorganosilsesquioxane (a1) can be manufactured by known manufacturing methods such as a method of hydrolyzing and condensing a hydrolyzable silane compound. As the hydrolyzable silane compound, it is preferable to use a hydrolyzable trifunctional silane compound having a group containing a hydrogen atom capable of forming a hydrogen bond (preferably a compound represented by General Formula (Sd1-1)) and a hydrolyzable trifunctional silane compound having a crosslinkable group (preferably a compound represented by General Formula (Sd2-1)).

The compound represented by General Formula (Sd1-1) corresponds to the constitutional unit represented by general Formula (S1-1), and the compound represented by General Formula (Sd2-1) corresponds to the constitutional unit represented by General Formula (S2-1).

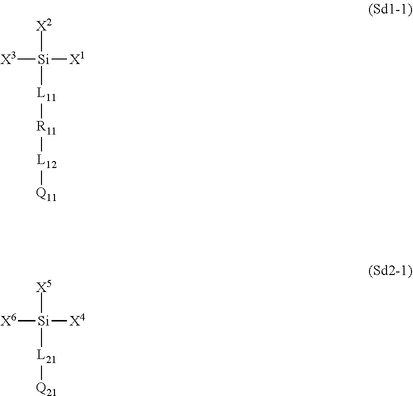

In General Formula (Sd1-1), X¹ to X³ each independently represent an alkoxy group or a halogen atom, L₁₁ represents a substituted or unsubstituted alkylene group, R₁₁ represents a single bond, —NH—, —O—, —C(═O)—, or a divalent linking group obtained by combining these. L₁₂ represents a substituted or unsubstituted alkylene group, and Q₁₁ represents a crosslinkable group. Here, the constitutional unit represented by General Formula (S1-1) has at least one group containing a hydrogen atom capable of forming a hydrogen bond.

In General Formula (Sd2-1), X⁴ to X⁶ each independently represent an alkoxy group or a halogen atom, L₂₁ represents a substituted or unsubstituted alkylene group, and Q₂₁ represents a crosslinkable group.

L₁₁, R₁₁, L₁₂, and Q₁₁ in General Formula (Sd1-1) have the same definition as Lu, Ru, L₁₂, and Q₁₁ in General Formula (S1-1) respectively, and preferable ranges thereof are also the same.

L₂₁ and Q₂₁ in General Formula (Sd2-1) have the same definition as L₂₁ and Q₂₁ in General Formula (S2-1) respectively, and preferable ranges thereof are also the same.

In General Formulas (Sd1-1) and (Sd2-1), X¹ to X⁶ each independently represent an alkoxy group or a halogen atom.

Examples of the alkoxy group include an alkoxy group having 1 to 4 carbon atoms such as a methoxy group, an ethoxy group, a propoxy group, an isopropyloxy group, a butoxy group, and an isobutyloxy group.

Examples of the halogen atom include a fluorine atom, a chlorine atom, a bromine atom, an iodine atom, and the like.

As X¹ to X⁵, an alkoxy group is preferable, and a methoxy group and an ethoxy group are more preferable. X¹ to X⁶ may be the same or different from each other.

The amount of the above hydrolyzable silane compounds used and the composition thereof can be appropriately adjusted depending on the desired structure of the polyorganosilsesquioxane (a1).

Furthermore, the hydrolysis and condensation reactions of the hydrolyzable silane compounds can be performed simultaneously or sequentially. In a case where the above reactions are sequentially performed, the order of performing the reactions is not particularly limited.

The hydrolysis and condensation reactions of the hydrolyzable silane compounds can be carried out in the presence or absence of a solvent, and are preferably carried out in the presence of a solvent.

Examples of the solvent include aromatic hydrocarbons such as benzene, toluene, xylene, and ethylbenzene: ethers such as diethyl ether, dimethoxyethane, tetrahydrofuran, and dioxane; ketones such as acetone, methyl ethyl ketone, and methyl isobutyl ketone; esters such as methyl acetate, ethyl acetate, isopropyl acetate, and butyl acetate; amides such as N,N-dimethylformamide and N,N-dimethylacetamide: nitriles such as acetonitrile, propionitrile, and benzonitrile; alcohols such as methanol, ethanol, isopropyl alcohol, and butanol, and the like.

As the solvent, ketones or ethers are preferable. One solvent can be used alone, or two or more solvents can be used in combination.

The amount of the solvent used is not particularly limited. Usually, the amount of the solvent used can be appropriately adjusted depending on the desired reaction time or the like, so that the amount falls into a range of 0 to 2,000 parts by mass with respect to the total amount (100 parts by mass) of the hydrolyzable silane compounds.

The hydrolysis and condensation reactions of the hydrolyzable silane compounds are preferably performed in the presence of a catalyst and water. The catalyst may be an acid catalyst or an alkali catalyst.

The acid catalyst is not particularly limited, and examples thereof include mineral acids such as hydrochloric acid, sulfuric acid, nitric acid, phosphoric acid, and boric acid; phosphoric acid esters: carboxylic acids such as acetic acid, formic acid, and trifluoroacetic acid: sulfonic acids such as methanesulfonic acid, trifluoromethanesulfonic acid, and p-toluenesulfonic acid; solid acids such as activated clay. Lewis acids such as iron chloride, and the like.

The alkali catalyst is not particularly limited, and examples thereof include alkali metal hydroxides such as lithium hydroxide, sodium hydroxide, potassium hydroxide, and cesium hydroxide; alkali earth metal hydroxides such as magnesium hydroxide, calcium hydroxide, and barium hydroxide: alkali metal carbonate such as lithium carbonate, sodium carbonate, potassium carbonate, and cesium carbonate: alkali earth metal carbonates such as magnesium carbonate; alkali metal hydrogen carbonates such as lithium hydrogen carbonate, sodium hydrogen carbonate, potassium hydrogen carbonate, and cesium hydrogen carbonate; alkali metal organic acid salts (for example, acetate) such as lithium acetate, sodium acetate, potassium acetate, and cesium acetate; alkali earth metal organic acid salts (for example, acetate) such as magnesium acetate; alkali metal alkoxides such as lithium methoxide, sodium methoxide, sodium ethoxide, sodium isopropoxide, potassium ethoxide, and potassium t-butoxide; alkali metal phenoxides such as sodium phenoxide; amines (tertiary amines and the like) such as triethylamine, N-methylpiperidine, 1,8-diazabicyclo[5.4.0]undec-7-ene, and 1,5-diazabicyclo[4.3.0]non-5-ene: nitrogen-containing aromatic heterocyclic compounds such as pyridine, 2,2′-bipyridyl, and 1,10-phenanthroline, and the like.

One catalyst can be used alone, or two or more catalysts can be used in combination. Furthermore, the catalyst can be used in a state of being dissolved or dispersed in water, a solvent, or the like.

The amount of the catalyst used is not particularly limited. Usually, the amount of the catalyst used can be appropriately adjusted within a range of 0.002 to 0.200 mol with respect to the total amount (1 mol) of the hydrolyzable silane compounds.

The amount of water used in the above hydrolysis and condensation reactions is not particularly limited. Usually, the amount of water used can be appropriately adjusted within a range of 0.5 to 40 mol with respect to the total amount (1 mol) of the hydrolyzable silane compounds.

The method of adding water is not particularly limited. The entirety of water to be used (total amount of water to be used) may be added at once or added sequentially. In a case where water is added sequentially, the water may be added continuously or intermittently.

The reaction temperature of the hydrolysis and condensation reactions is not particularly limited. For example, the reaction temperature is 40° C. to 100° C. and preferably 45° C. to 80° C. The reaction time of the hydrolysis and condensation reactions is not particularly limited. For example, the reaction time is 0.1 to 15 hours and preferably 1.5 to 10 hours. Furthermore, the hydrolysis and condensation reactions can be carried out under normal pressure or under pressure that is increased or reduced. The hydrolysis and condensation reactions may be performed, for example, in any of a nitrogen atmosphere, an inert gas atmosphere such as argon gas atmosphere, or an aerobic atmosphere such as an air atmosphere. Among these, the inert gas atmosphere is preferable.

By the hydrolysis and condensation reactions of the hydrolyzable silane compounds described above, the polyorganosilsesquioxane (a1) can be obtained. After the hydrolysis and condensation reactions end, the catalyst may be neutralized. In addition, the polyorganosilsesquioxane (a1) may be separated and purified by a separation method such as rinsing, acid cleaning, alkali cleaning, filtration, concentration, distillation, extraction, crystallization, recrystallization, or column chromatography, or by a separation method using these in combination.

One polyorganosilsesquioxane (a1) may be used alone, or two or more polyorganosilsesquioxanes (a1) having different structures may be used in combination.

The content rate of the polyorganosilsesquioxane (a1) in the composition for forming a hardcoat layer is not particularly limited. The content rate of the polyorganosilsesquioxane (a1) with respect to the total solid content of the composition for forming a hardcoat layer is preferably 50% by mass or more, more preferably 70% by mass or more, and even more preferably 80% by mass or more. The content rate of the polyorganosilsesquioxane (a1) in the composition for forming a hardcoat layer with respect to the total solid content of the composition for forming a hardcoat layer is preferably 99.9% by mass or less, more preferably 98% by mass or less, and even more preferably 97% by mass or less.

The total solid content means all components other than solvents.

<Polymerization Initiator>

It is preferable that the composition for forming a hardcoat layer contain a polymerization initiator.

In a case where the polyorganosilsesquioxane (a1) used in the composition for forming a hardcoat layer has a radically polymerizable crosslinkable group as a crosslinkable group, it is preferable that the composition contain a radical polymerization initiator. In a case where the polyorganosilsesquioxane (a1) used in the composition for forming a hardcoat layer has a cationically polymerizable crosslinkable group as a crosslinkable group, it is preferable that the composition contain a cationic polymerization initiator.

The polymerization initiator is preferably a radical polymerization initiator. The radical polymerization initiator may be a radical photopolymerization initiator or a radical thermal polymerization initiator, and is more preferably a radical photopolymerization initiator.

One polymerization initiator may be used alone, or two or more polymerization initiators having different structures may be used in combination.

As the radical photopolymerization initiator, known radical photopolymerization initiators can be used without particular limitation, as long as the initiators can generate radicals as active species by light irradiation. Specific examples thereof include acetophenones such as diethoxyacetophenone, 2-hydroxy-2-methyl-1-phenylpropan-1-one, benzyl dimethyl ketal, 4-(2-hydroxyethoxy)phenyl-(2-hydroxy-2-propyl)ketone, 1-hydroxycyclohexyl phenyl ketone, 2-methyl-2-morpholino(4-thiomethylphenyl)propan-1-one, 2-benzyl-2-dimethylamino-1-(4-morpholinophenyl)butanone, a 2-hydroxy-2-methyl-1-[4-(1-methylvinyl)phenyl]propanone oligomer, and 2-hydroxy-1-{4-[4-(2-hydroxy-2-methyl-propionyl)-benzyl]phenyl}-2-methyl-propan-1-one; oxime esters such as 1,2-octanedione, 1-[4-(phenylthio)-,2-(O-benzoyloxime)], ethanone,1-[9-ethyl-6-(2-methylbenzoyl)-9H-carbazol-3-yl]-,1-(0-acetyloxime); benzoins such as benzoin, benzoin methyl ether, benzoin ethyl ether, benzoin isopropyl ether, and benzoin isobutyl ether; benzophenones such as benzophenone, methyl o-benzoyl benzoate, 4-phenylbenzophenone, 4-benzoyl-4′-methyl-diphenyl sulfide, 3,3′4,4′-tetra(t-butylperoxycarbonyl)benzophenone, 2,4,6-trimethylbenzophenone, 4-benzoyl-N,N-dimethyl-N-[2-(l-oxo-2-propenyloxy)ethyl]benzene methanaminium bromide, and (4-benzoylbenzyl)trimethyl ammonium chloride; thioxanthones such as 2-isopropylthioxanthone, 4-isopropylthioxanthone, 2,4-diethylthioxanthone, 2,4-dichlorothioxanthone, 1-chloro-4-propoxythioxanthone, and 2-(3-dimethylamino-2-hydroxy)-3,4-dimethyl-9H-thioxanthone-9-one methochloride; acylphosphine oxides such as 2,4,6-trimethylbenzoyl-diphenylphosphine oxide, bis(2,6-dimethoxybenzoyl)-2,4,4-trimethyl-pentylphosphine oxide, and bis(2,4,6-trimethylbenzoyl)-phenylphosphine oxide; and the like. Furthermore, as an aid for the radical photopolymerization initiator, triethanolamine, triisopropanolamine, 4,4′-dimethylaminobenzophenone (Michler's ketone), 4,4′-diethylaminobenzophenone, 2-dimethylaminoethyl benzoate, ethyl 4-dimethylaminobenzoate, (n-butoxy)ethyl 4-dimethylaminobenzoate, isoamyl 4-dimethylaminobenzoate, 2-ethylhexyl 4-dimethylaminobenzoate, 2,4-diethylthioxanthone, 2,4-diisopropylthioxanthone, and the like may be used in combination.

The above radical photopolymerization initiators and aids can be synthesized by a known method or are available as commercial products.

The content rate of the polymerization initiator in the composition for forming a hardcoat layer is not particularly limited. For example, the content rate with respect to 100 parts by mass of the polyorganosilsesquioxane (a1) is preferably 0.1 to 200 parts by mass, and more preferably 1 to 50 parts by mass.

<Solvent>

The composition for forming a hardcoat layer may contain a solvent.

As the solvent, an organic solvent is preferable. One organic solvent can be used, or two or more organic solvents can be used by being mixed together at any ratio. Specific examples of the organic solvent include alcohols such as methanol, ethanol, propanol, n-butanol, and i-butanol; ketones such as acetone, methyl isobutyl ketone, methyl ethyl ketone, and cyclohexanone: cellosolves such as ethyl cellosolve; aromatic solvents such as toluene and xylene: glycol ethers such as propylene glycol monomethyl ether; acetic acid esters such as methyl acetate, ethyl acetate, and butyl acetate; diacetone alcohol: and the like.

The content rate of the solvent in the composition for forming a hardcoat layer can be appropriately adjusted within a range in which the coating suitability of the composition for forming a hardcoat layer can be ensured. For example, the content rate of the solvent with respect to the total solid content, 100 parts by mass, of the composition for forming a hardcoat layer can be 50 to 500 parts by mass, and preferably 80 to 200 parts by mass.

The composition for forming a hardcoat layer is generally in the form of a liquid.

Generally, the concentration of solid contents of the composition for forming a hardcoat layer is about 10% to 90% by mass, preferably about 20% to 80% by mass, and particularly preferably about 40% to 70% by mass.

<Other Additives>

The composition for forming a hardcoat layer may contain components other than the above, for example, inorganic particles, a dispersant, a leveling agent, an antifouling agent, an antistatic agent, an ultraviolet absorber, an antioxidant, and the like.

The composition for forming a hardcoat layer can be prepared by simultaneously mixing together the various components described above or sequentially mixing together the various components described above in any order. The preparation method is not particularly limited, and the composition can be prepared using a known stirrer or the like.

The hardcoat layer of the hardcoat film according to an embodiment of the present invention preferably contains a cured product of the composition for forming a hardcoat layer containing the polyorganosilsesquioxane (a1), and more preferably contains a cured product of the composition for forming a hardcoat layer containing the polyorganosilsesquioxane (a1) and a polymerization initiator.

It is preferable that the cured product of the composition for forming a hardcoat layer include at least a cured product produced by the bonding of crosslinkable groups of the polyorganosilsesquioxane (a1) through a polymerization reaction.

In the hardcoat layer of the hardcoat film according to an embodiment of the present invention, the content rate of the cured product of the composition for forming a hardcoat layer is preferably 50% by mass or more, more preferably 60% by mass or more, and even more preferably 70% by mass or more.

[Material of Substrate]

Preferred aspects of the material of the substrate (material forming the substrate) in the hardcoat film according to an embodiment of the present invention and the like will be described.

The transmittance of the substrate used in the hardcoat film according to an embodiment of the present invention in a visible light region is preferably 70% or more, more preferably 80% or more, and even more preferably 90% or more.

(Polymer)

The substrate preferably contains a polymer.

As the polymer, a polymer excellent in optical transparency, mechanical strength, heat stability, and the like is preferable.

Examples of such a polymer include polycarbonate-based polymers, polyester-based polymers such as polyethylene terephthalate (PET) and polyethylene naphthalate (PEN), styrene-based polymers such as polystyrene and an acrylonitrile/styrene copolymer (AS resin), and the like. The examples also include polyolefins such as polyethylene and polypropylene, norbomene-based resins, polyolefin-based polymers such as ethylene/propylene copolymers, (meth)acrylic polymers such as polymethyl methacrylate, vinyl chloride-based polymers, amide-based polymers such as nylon and aromatic polyamide, imide-based polymers, sulfone-based polymers, polyether sulfone-based polymers, polyether ether ketone-based polymers, polyphenylene sulfide-based polymers, vinylidene chloride-based polymers, vinyl alcohol-based polymers, vinyl butyral-based polymers, arylate-based polymers, polyoxymethylene-based polymers, epoxy-based polymers, cellulose-based polymers represented by triacetyl cellulose, copolymers of the above polymers, and polymers obtained by mixing together the above polymers.

Particularly, amide-based polymers such as aromatic polyamide and imide-based polymers can be preferably used as the substrate, because the number of times of folding at break measured for these polymers by an MIT tester according to Japanese Industrial Standards (JIS) P8115 (2001) is large, and these polymers have relatively high hardness. For example, the aromatic polyamide described in Example 1 of JP5699454B and the polyimides described in JP2015-508345A. JP2016-521216A, and WO2017/014287A can be preferably used as the substrate.

As the amide-based polymer, aromatic polyamide (aramid-based polymer) is preferable.

It is preferable that the substrate contain at least one polymer selected from imide-based polymers or aramid-based polymers.

The substrate can also be formed as a cured layer of an ultraviolet curable resin or a thermosetting resin based on acryl, urethane, acrylic urethane, epoxy, silicone, and the like.

(Softening Material)

The substrate may contain a material that further softens the polymer described above. The softening material refers to a compound that improves the number of times of folding at break. As the softening material, it is possible to use a rubber elastic material, a brittleness improver, a plasticizer, a slide ring polymer, and the like.

Specifically, as the softening material, the softening materials described in paragraphs “0051” to “0114” of JP2016-167043A can be suitability used.

The softening material may be mixed alone with the polymer, or a plurality of softening materials may be appropriately used in combination. Furthermore, the substrate may be prepared using one softening material or a plurality of softening materials without being mixed with the polymer.

That is, the amount of the softening material to be mixed is not particularly limited. A polymer having the sufficient number of times of folding at break itself may be used alone as the substrate of the film or may be mixed with the softening material, or the substrate may be totally (100%) composed of the softening material so that the number of times of folding at break becomes sufficient.

(Other Additives)

Various additives (for example, an ultraviolet absorber, a matting agent, an antioxidant, a peeling accelerator, a retardation (optical anisotropy) regulator, and the like) can be added to the substrate according to the use. These additives may be solids or oily substances. That is, the melting point or boiling point thereof is not particularly limited. In addition, the additives may be added at any point in time in the step of preparing the substrate, and a step of preparing a material by adding additives may be added to a material preparation step. Furthermore, the amount of each material added is not particularly limited as long as each material performs its function.

As those other additives, the additives described in paragraphs “0117” to “0122” of JP2016-167043A can be suitably used.

Each of the above additives may be used alone, or two or more additives among the above additives may be used in combination.

(Ultraviolet Absorber)

Examples of the ultraviolet absorber include a benzotriazole compound, a triazine compound, and a benzoxazine compound. The benzotriazole compound is a compound having a benzotriazole ring, and specific examples thereof include various benzotriazole-based ultraviolet absorbers described in paragraph “0033” of JP2013-111835A. The triazine compound is a compound having a triazine ring, and specific examples thereof include various triazine-based ultraviolet absorbers described in paragraph “0033” of JP2013-111835A. As the benzoxazine compound, for example, those described in paragraph “0031” of JP2014-209162A can be used. The content of the ultraviolet absorber in the substrate is, for example, about 0.1 to 10 parts by mass with respect to 100 parts by mass of the polymer contained in the substrate, but is not particularly limited. Regarding the ultraviolet absorber, paragraph “0032” of JP2013-111835A can also be referred to. In the present invention, an ultraviolet absorber having high heat resistance and low volatility is preferable. Examples of such an ultraviolet absorber include UVSORB101 (manufactured by FUJIFILM Finechemicals Co., Ltd.), TINUVIN 360, TINUVIN 460, and TINUVIN 1577 (manufactured by BASF SE), LA-F70, LA-31, and LA-46 (manufactured by ADEKA CORPORATION), and the like.

From the viewpoint of transparency, it is preferable that the difference between a refractive index of the softening material and various additives used in the substrate and a refractive index of the polymer be small.

(Substrate Containing Imide-Based Polymer)

As the substrate, a substrate containing an imide-based polymer can be preferably used. In the present specification, the imide-based polymer means a polymer containing at least one or more repeating structural units represented by Formula (PI), Formula (a), Formula (a′), or Formula (b). Particularly, from the viewpoint of hardness and transparency of the film, it is preferable that the repeating structural unit represented by Formula (PI) be the main structural unit of the imide-based polymer. The amount of the repeating structural unit represented by Formula (PI) with respect to the total amount of the repeating structural units in the imide-based polymer is preferably 40 mol %, or more preferably 50 mol % or more, even more preferably 70 mol % or more, particularly preferably 90 mol % or more, and most preferably 98 mol % or more.

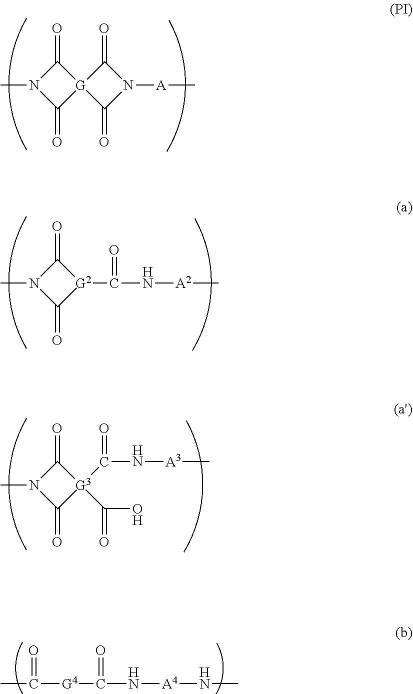

In Formula (PI), G represents a tetravalent organic group, and A represents a divalent organic group. In Formula (a), G² represents a trivalent organic group, and A² represents a divalent organic group. In Formula (a′), G³ represents a tetravalent organic group, and A³ represents a divalent organic group. In Formula (b), G⁴ and A⁴ each represent a divalent organic group.

Examples of the organic group as the tetravalent organic group represented by G in Formula (P1) (hereinafter, sometimes called organic group of G) include a group selected from the group consisting of an acyclic aliphatic group, a cyclic aliphatic group, and an aromatic group. From the viewpoint of transparency and flexibility of the substrate containing the imide-based polymer, the organic group of(G is preferably a tetravalent cyclic aliphatic group or a tetravalent aromatic group. Examples of the aromatic group include a monocyclic aromatic group, a condensed polycyclic aromatic group, a non-condensed polycyclic aromatic group having two or more aromatic rings which are linked to each other directly or through a linking group, and the like. From the viewpoint of transparency and coloration inhibition of the substrate, the organic group of G³ is preferably a cyclic aliphatic group, a cyclic aliphatic group having a fluorine-based substituent, a monocyclic aromatic group having a fluorine-based substituent, a condensed polycyclic aromatic group having a fluorine-based substituent, or a non-condensed polycyclic aromatic group having a fluorine-based substituent. In the present specification, the fluorine-based substituent means a group containing a fluorine atom. The fluorine-based substituent is preferably a fluoro group (fluorine atom, —F) and a perfluoroalkyl group, and more preferably a fluoro group and a trifluoromethyl group.

More specifically, the organic group of G is selected, for example, from a saturated or unsaturated cycloalkyl group, a saturated or unsaturated heterocycloalkyl group, an aryl group, a heteroaryl group, an arylalkyl group, an alkylaryl group, a heteroalkylaryl group, and a group having any two groups (which may be the same as each other) among these that are linked to each other directly or through a linking group. Examples of the linking group include —O—, an alkylene group having 1 to 10 carbon atoms, —SO₂—, —CO—, and —CO—NR— (R represents an alkyl group having 1 to 3 carbon atoms such as a methyl group, an ethyl group, or a propyl group or a hydrogen atom).

The tetravalent organic group represented by G usually has 2 to 32 carbon atoms, preferably has 4 to 15 carbon atoms, more preferably has 5 to 10 carbon atoms, and even more preferably has 6 to 8 carbon atoms. In a case where the organic group of G is a cyclic aliphatic group or an aromatic group, at least one of the carbon atoms constituting these groups may be substituted with a hetero atom. Examples of the hetero atom include 0, N. and S.

Specific examples of G include groups represented by Formula (20), Formula (21), Formula (22). Formula (23), Formula (24), formula (25), or Formula (26). * in each formula represents a bond. In Formula (26). Z represents a single bond, —O—, —CH₂—, —C(CH₃)₂—, —Ar—O—Ar—, —Ar—CH₂—Ar—, —Ar—C(CH₃)₂—Ar—, or —Ar—SO₂—Ar—. Ar represents an aryl group having 6 to 20 carbon atoms. Ar may be, for example, a phenylene group. At least one of the hydrogen atoms in these groups may be substituted with a fluorine-based substituent.

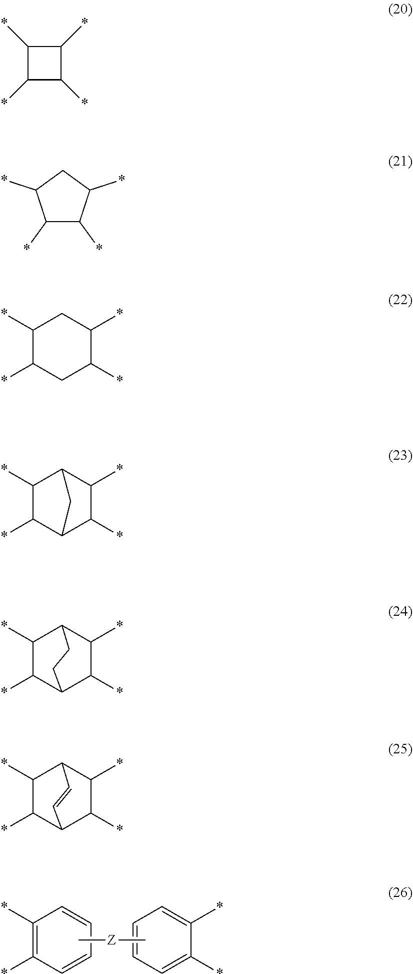

Examples of the organic group as the divalent organic group represented by A in Formula (PI) (hereinafter, sometimes called organic group of A) include a group selected from the group consisting of an acyclic aliphatic group, a cyclic aliphatic group, and an aromatic group. The divalent organic group represented by A is preferably selected from a divalent cyclic aliphatic group and a divalent aromatic group. Examples of the aromatic group include a monocyclic aromatic group, a condensed polycyclic aromatic group, and a non-condensed polycyclic aromatic group having two or more aromatic rings which are linked to each other directly or through a linking group. From the viewpoint of transparency and coloration inhibition of the substrate, it is preferable that a fluorine-based substituent be introduced into the organic group of A.

More specifically, the organic group of A is selected, for example, from a saturated or unsaturated cycloalkyl group, a saturated or unsaturated heterocycloalkyl group, an aryl group, a heteroaryl group, an arylalkyl group, an alkylaryl group, a heteroalkylaryl group, and a group having any two groups (which may be the same as each other) among these that are linked to each other directly or through a linking group. Examples of the hetero atom include O, N, and S. Examples of the linking group include —O—, an alkylene group having 1 to 10 carbon atoms, —SO₂—, —CO—, and —CO—NR— (R represents an alkyl group having 1 to 3 carbon atoms such as a methyl group, an ethyl group, or a propyl group or a hydrogen atom).

The divalent organic group represented by A usually has 2 to 40 carbon atoms, preferably has 5 to 32 carbon atoms, more preferably has 12 to 28 carbon atoms, and even more preferably has 24 to 27 carbon atoms.

Specific examples of A include groups represented by Formula (30), Formula (31), Formula (32), Formula (33), or Formula (34). * in each formula represents a bond. Z¹ to Z³ each independently represent a single bond, —O—, —CH₂—, —C(CH₃)₂—, —SO₂—, —CO—, or —CO—NR—(R represents an alkyl group having 1 to 3 carbon atoms such as a methyl group, an ethyl group, or a propyl group or a hydrogen atom). In the following groups. Z¹ and Z² as well as Z² and Z³ are preferably in the meta position or para position respectively for each ring. Furthermore, it is preferable that Z¹ and a terminal single bond, Z² and a terminal single bond, and Z³ and a terminal single bond be in the meta position or para position respectively. For example, in A, Z¹ and Z³ represent —O—, and Z² represents —CH₂—, —C(CH₃)₂—, or —SO₂—. One hydrogen atom or two or more hydrogen atoms in these groups may be substituted with a fluorine-based substituent.

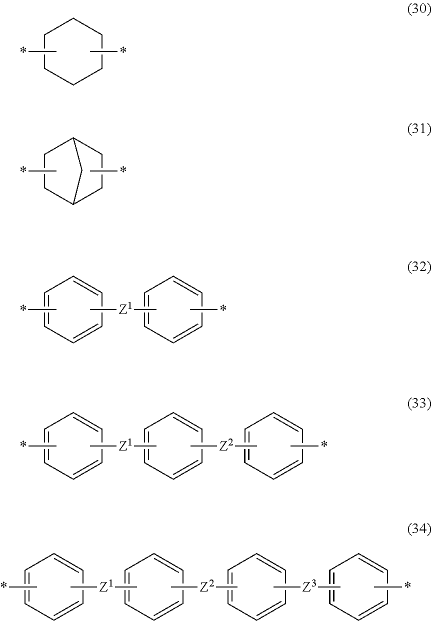

At least one of the hydrogen atoms constituting at least one of A or G may be substituted with at least one functional group selected from the group consisting of a fluorine-based substituent, a hydroxyl group, a sulfone group, an alkyl group having 1 to 10 carbon atoms, and the like. Furthermore, in a case where each of the organic group of A and the organic group of G is a cyclic aliphatic group or an aromatic group, it is preferable that at least one of A or G have a fluorine-based substituent, and it is more preferable that both the A and G have a fluorine-based substituent.

G² in Formula (a) represents a trivalent organic group. This organic group can be selected from the same group as the organic group of G in formula (PI), except that G² is a trivalent group. Examples of G² include groups represented by Formula (20) to Formula (26) listed above as specific examples of G in which any one of the four bonds is substituted with a hydrogen atom. A² in Formula (a) can be selected from the same group as A in Formula (PI).

G³ in Formula (a′) can be selected from the same group as G in Formula (PI). A3 in Formula (a′) can be selected from the same group as A in Formula (PI).

G⁴ in Formula (b) represents a divalent organic group. This organic group can be selected from the same group as the organic group of G in formula (PI), except that G⁴ is a divalent group. Examples of G⁴ include groups represented by Formula (20) to Formula (26) listed above as specific examples of G in which any two of the four bonds are substituted with a hydrogen atom. A⁴ in Formula (b) can be selected from the same group as A in Formula (PI).

The imide-based polymer contained in the substrate containing the imide-based polymer may be a condensed polymer obtained by the polycondensation of diamines and at least one tetracarboxylic acid compound (including a tetracarboxylic acid compound analog such as an acid chloride compound or a tetracarboxylic dianhydride) or one tricarboxylic acid compound (including a tricarboxylic acid compound analog such as an acid chloride compound or a tricarboxylic anhydride). Furthermore, a dicarboxylic acid compound (including an analog such as an acid chloride compound) may also take part in the polycondensation. The repeating structural unit represented by Formula (PI) or Formula (a′) is usually derived from diamines and a tetracarboxylic acid compound. The repeating structural unit represented by Formula (a) is usually derived from diamines and a tricarboxylic acid compound. The repeating structural unit represented by Formula (b) is usually derived from diamines and a dicarboxylic acid compound.

Examples of the tetracarboxylic acid compound include an aromatic tetracarboxylic acid compound, an alicyclic tetracarboxylic acid compound, an acyclic aliphatic tetracarboxylic acid compound, and the like. Two or more of these compounds may be used in combination. The tetracarboxylic acid compound is preferably tetracarboxylic dianhydride. Examples of the tetracarboxylic dianhydride include an aromatic tetracarboxylic dianhydride, an alicyclic tetracarboxylic dianhydride, and an acyclic aliphatic tetracarboxylic dianhydride.

From the viewpoint of solubility of the imide-based polymer in a solvent and from the viewpoint of transparency and flexibility of the formed substrate, the tetracarboxylic acid compound is preferably an alicyclic tetracarboxylic acid compound, an aromatic tetracarboxylic acid compound, or the like. From the viewpoint of transparency and coloration inhibition of the substrate containing the imide-based polymer, the tetracarboxylic acid compound is preferably a compound selected from an alicyclic tetracarboxylic acid compound having a fluorine-based substituent and an aromatic tetracarboxylic acid compound having a fluorine-based substituent, and more preferably an alicyclic tetracarboxylic acid compound having a fluorine-based substituent.

Examples of the tricarboxylic acid compound include an aromatic tricarboxylic acid, an alicyclic tricarboxylic acid, an acyclic aliphatic tricarboxylic acid, an acid chloride compound or an acid anhydride that is structurally similar to these, and the like. The tricarboxylic acid compound is preferably selected from an aromatic tricarboxylic acid, an alicyclic tricarboxylic acid, an acyclic aliphatic tricarboxylic acid, and an acid chloride compound that is structurally similar to these. Two or more tricarboxylic acid compounds may be used in combination.

From the viewpoint of solubility of the imide-based polymer in a solvent and from the viewpoint of transparency and flexibility of the formed substrate containing the imide-based polymer, the tricarboxylic acid compound is preferably an alicyclic tricarboxylic acid compound or an aromatic tricarboxylic acid compound. From the viewpoint of transparency and coloration inhibition of the substrate containing the imide-based polymer, the tricarboxylic acid compound is more preferably an alicyclic tricarboxylic acid compound having a fluorine-based substituent or an aromatic tricarboxylic acid compound having a fluorine-based substituent.

Examples of the dicarboxylic acid compound include an aromatic dicarboxylic acid, an alicyclic dicarboxylic acid, an acyclic aliphatic dicarboxylic acid, an acid chloride compound or an acid anhydride that is structurally similar to these, and the like. The dicarboxylic acid compound is preferably selected from an aromatic dicarboxylic acid, an alicyclic dicarboxylic acid, an acyclic aliphatic dicarboxylic acid, and an acid chloride compound that is structurally similar to these. Two or more dicarboxylic acid compounds may be used in combination.

From the viewpoint of solubility of the imide-based polymer in a solvent and from the viewpoint of transparency and flexibility of the formed substrate containing the imide-based polymer, the dicarboxylic acid compound is preferably an alicyclic dicarboxylic acid compound or an aromatic dicarboxylic acid compound. From the viewpoint of transparency and coloration inhibition of the substrate containing the imide-based polymer, the dicarboxylic acid compound is more preferably an alicyclic dicarboxylic acid compound having a fluorine-based substituent or an aromatic dicarboxylic acid compound having a fluorine-based substituent.

Examples of the diamines include an aromatic diamine, an alicyclic diamine, and an aliphatic diamine. Two or more of these may be used in combination. From the viewpoint of solubility of the imide-based polymer in a solvent and from the viewpoint of transparency and flexibility of the formed substrate containing the imide-based polymer, the diamines are preferably selected from an alicyclic diamine and an aromatic diamine having a fluorine-based substituent.

In a case where such an imide-based polymer is used, it is easy to obtain a substrate having particularly excellent flexibility, high light transmittance (for example, 85% or more and preferably 88% or more for light at 550 nm), low yellowness (YI value that is 5 or less and preferably 3 or less), and low haze (1.5% or less and preferably 1.0% or less).

The imide-based polymer may be a copolymer containing a plurality of different kinds of repeating structural units described above. The weight-average molecular weight of the polyimide-based polymer is generally 10,000 to 500,000. The weight-average molecular weight of the imide-based polymer is preferably 50,000 to 500,000, and more preferably 70,000 to 400.000. The weight-average molecular weight is a molecular weight measured by gel permeation chromatography (GPC) and expressed in terms of standard polystyrene. In a case where the weight-average molecular weight of the imide-based polymer is large, high flexibility tends to be easily obtained. However, in a case where the weight-average molecular weight of the imide-based polymer is too large, the viscosity of varnish increases, and workability tends to deteriorate accordingly.

The imide-based polymer may contain a halogen atom such as a fluorine atom which can be introduced into the polymer by the aforementioned fluorine-based substituent or the like. In a case where the polyimide-based polymer contains a halogen atom, the elastic modulus of the substrate containing the imide-based polymer can be improved, and the yellowness can be reduced. As a result, the occurrence of scratches, wrinkles, and the like in the hardcoat film can be inhibited, and the transparency of the substrate containing the imide-based polymer can be improved. The halogen atom is preferably a fluorine atom. The content of the halogen atom in the polyimide-based polymer based on the mass of the polyimide-based polymer is preferably 1% to 40% by mass, and more preferably 1% to 30% by mass.

The substrate containing the imide-based polymer may contain one ultraviolet absorber or two or more ultraviolet absorbers. The ultraviolet absorber can be appropriately selected from compounds that are generally used as ultraviolet absorbers in the field of resin materials. The ultraviolet absorber may include a compound that absorbs light having a wavelength of 400 nm or less. Examples of the ultraviolet absorber that can be appropriately combined with the imide-based polymer include at least one compound selected from the group consisting of a benzophenone-based compound, a salicylate-based compound, a benzotriazole-based compound, and a triazine-based compound.

In the present specification, “-based compound” means a derivative of the compound following “-based”. For example, “benzophenone-based compound” refers to a compound having benzophenone as a base skeleton and a substituent bonded to the benzophenone.

The content of the ultraviolet absorber with respect to the total mass of the substrate is generally 1% by mass or more, preferably 2% by mass or more, and more preferably 3% by mass or more. The content of the ultraviolet absorber with respect to the total mass of the substrate is generally 10% by mass or less, preferably 8% by mass or less, and even more preferably 6% by mass or less. In a case where the content of the ultraviolet absorber is within the above range, the weather fastness of the substrate can be improved.

The substrate containing the imide-based polymer may further contain an inorganic material such as inorganic particles. The inorganic material is preferably a silicon material containing silicon atoms. In a case where the substrate containing the imide-based polymer contains an inorganic material such as silicon material, it is easy to set the tensile elastic modulus of the substrate containing the imide-based polymer to a value of 4.0 GPa or more. However, mixing the substrate containing the imide-based polymer with an inorganic material is not the only way to control the tensile elastic modulus of the substrate.

Examples of the silicon material containing silicon atoms include silica particles, quaternary alkoxysilane such as tetraethyl orthosilicate (TEOS), and a silicon compound such as a silsesquioxane derivative. Among these silicon materials, from the viewpoint of transparency and flexibility of the substrate containing the imide-based polymer, silica particles are preferable.

The average primary particle size of the silica particles is generally 100 nm or less. In a case where the average primary particle size of the silica particles is 100 nm or less, the transparency tends to be improved.

The average primary particle size of the silica particles in the substrate containing the imide-based polymer can be determined by the observation with a transmission electron microscope (TEM). As the primary particle size of the silica particles, the Feret's diameter measured using a transmission electron microscope (TEM) can be adopted. The average primary particle size can be determined by measuring primary particle sizes at 10 spots by TEM observation and calculating the average thereof. The particle size distribution of the silica particles that have not yet form the substrate containing the imide-based polymer can be determined using a commercially available laser diffraction particle size distribution analyzer.

In the substrate containing the imide-based polymer, in a case where the total amount of the imide-based polymer and the inorganic material is regarded as 10, the mixing ratio of imide-based polymer:inorganic material based on mass is preferably 1:9 to 10:0, more preferably 3:7 to 10:0, even more preferably 3:7 to 8:2, and still more preferably 3:7 to 7:3. The ratio of the inorganic material to the total mass of the imide-based polymer and the inorganic material is generally 20% by mass or more, and preferably 30% by mass or more. The ratio of the inorganic material to the total mass of the imide-based polymer and the inorganic material is generally 90% by mass or less, and preferably 70% by mass or less. In a case where the mixing ratio of imide-based polymer:inorganic material (silicon material) is within the above range, the transparency and mechanical strength of the substrate containing the imide-based polymer tend to be improved. Furthermore, it is easy to set the tensile elastic modulus of the substrate containing the imide-based polymer to a value of 4.0 GPa or more.

As long as the transparency and flexibility are not markedly impaired, the substrate containing the imide-based polymer may further contain components other than the imide-based polymer and the inorganic material. Examples of components other than the imide-based polymer and the inorganic material include an antioxidant, a release agent, a stabilizer, a coloring agent such as a bluing agent, a flame retardant, a lubricant, a thickener, and a leveling agent. The ratio of components other than the imide-based polymer and the inorganic material to the mass of the substrate is preferably more than 0% and 20% by mass or less, and more preferably more than 0% and 10% by mass or less.

In a case where the substrate containing the imide-based polymer contains the imide-based polymer and the silicon material, Si/N which represents a ratio of the number of silicon atoms to the number of nitrogen atoms within at least one surface is preferably 8 or more. Si/N which represents the ratio of the number of atoms is a value calculated from the abundance of silicon atoms and the abundance of nitrogen atoms that are obtained by evaluating the composition of the substrate containing the imide-based polymer by X-ray photoelectron spectroscopy (XPS).

In a case where Si/N within at least one surface of the substrate containing the imide-based polymer is 8 or more, sufficient adhesiveness between the substrate and a hardcoat layer is obtained. From the viewpoint of adhesiveness, Si/N is more preferably 9 or more, and even more preferably 10 or more. Si/N is preferably 50 or less, and more preferably 40 or less.

(Method for Preparing Substrate)

The substrate may be prepared by heat-melting a thermoplastic polymer, or may be prepared from a solution, in which a polymer is uniformly dissolved, by solution film formation (a solvent casting method). In the case of heat-melting film formation, the softening material and various additives described above can be added during heat melting. In contrast, in a case where the substrate is prepared by the solution film formation method, the softening material and various additives described above can be added to the polymer solution (hereinafter, also called dope) in each preparation step. Furthermore, the softening material and various additives may be added at any point in time in a dope preparation process. In the dope preparation process, a step of preparing the dope by adding the additives may be additionally performed as a final preparation step.

In order to dry and/or bake the coating film, the coating film may be heated. The heating temperature of the coating film is generally 50° C. to 350° C. The coating film may be heated in an inert atmosphere or under reduced pressure. By the heating of the coating film, solvents can be evaporated and removed. The substrate may be formed by a method including a step of drying the coating film at 50° C. to 150° C. and a step of baking the dried coating film at 180° C. to 350° C.

A surface treatment may be performed on at least one surface of the substrate.

[Material of Anti-Scratch Layer]

Next, preferred aspects of the anti-scratch layer which may be provided on the hardcoat film according to the first aspect of the present invention, the material of the anti-scratch layer (material forming the anti-scratch layer) included in the hardcoat film according to the second aspect of the present invention, and the like will be described.

It is preferable that the anti-scratch layer be formed by curing a composition for forming an anti-scratch layer. That is, it is preferable that the anti-scratch layer contain a cured product of the composition for forming an anti-scratch layer.

In a case where the hardcoat film according to an embodiment of the present invention has an anti-scratch layer, it is preferable that at least one anti-scratch layer be provided on a surface of the hardcoat layer, the surface opposite to the substrate.

It is preferable that the anti-scratch layer contain a cured product of the composition for forming an anti-scratch layer containing a radically polymerizable compound (c1).

(Radically Polymerizable Compound (c1))

The radically polymerizable compound (cl) (also called “compound (cl)”) will be described.

The compound (cl) is a compound having a radically polymerizable group.

As the radically polymerizable group in the compound (cl), a generally known radically polymerizable group can be used without particular limitations. Examples of the radically polymerizable group include polymerizable unsaturated groups. Specifically, examples thereof include a (meth)acryloyl group, a vinyl group, an allyl group, and the like. Among these, a (meth)acryloyl group is preferable. Each of the above groups may have a substituent.

The compound (c1) is preferably a compound having two or more (meth)acryloyl groups in one molecule, and more preferably a compound having three or more (meth)acryloyl groups in one molecule.

The molecular weight of the compound (cl) is not particularly limited. The compound (c1) may be a monomer, an oligomer, or a polymer.

Specific examples of the compound (cl) will be shown below, but the present invention is not limited thereto.

As the compound having two (meth)acryloyl groups in one molecule, for example, neopentyl glycol di(meth)acrylate, 1,9-nonanediol di(meth)acrylate, dipropylene glycol di(meth)acrylate, tripropylene glycol di(meth)acrylate, tetraethylene glycol di(meth)acrylate, hydroxypivalic acid neopentyl glycol di(meth)acrylate, polyethylene glycol di(meth)acrylate, dicyclopentenyl (meth)acrylate, dicyclopentenyloxyethyl (meth)acrylate, dicyclopentanyl di(meth)acrylate, urethane (meth)acrylate, compounds obtained by the modification of these compounds (for example, alkylene oxide modification), and the like are suitable.

Examples of the compound having three or more (meth)acryloyl groups in one molecule include esters of a polyhydric alcohol and a (meth)acrylic acid. Specifically, examples thereof include pentaerythritol tri(meth)acrylate, pentaerythritol tetra(meth)acrylate, trimethylolpropane tri(meth)acrylate, trimethylolethane tri(meth)acrylate, ditrimethylolpropane tetra(meth)acrylate, dipentaerythritol tetra(meth)acrylate, dipentaerythritol pentaacrylate, dipentaerythritol hexaacrylate, pentaerythritol hexa(meth)acrylate, urethane (meth)acrylate, compounds obtained by the modification of these compounds (for example, alkylene oxide modification), and the like. In view of a high degree of crosslinking, pentaerythritol triacrylate, pentaerythritol tetraacrylate, or dipentaerythritol pentaacrylate, dipentaerythritol hexaacrylate, or a mixture of these is preferable.

In the present invention, from the viewpoint of obtaining a hardcoat film excellent in resistance to repeated folding, it is preferable to use a material that allows the anti-scratch layer to elongate as well to some extent. From this point of view, it is particularly preferable to use at least one of dipentaerythritol pentaacrylate, dipentaerythritol hexaacrylate, or a compound obtained by the modification of these compounds (for example, alkylene oxide modification). Examples of such a compound include KAYARAD DPCA-20, KAYARAD DPCA-30, KAYARAD DPCA-60, and KAYARAD DPCA-120 manufactured by Nippon Kayaku Co., Ltd., and the like. Examples of the urethane (meth)acrylate include U-4HA (manufactured by SHIN-NAKAMURA CHEMICAL CO, LTD.) and the like.

As the compound (c1), one compound may be used alone, or two or more compounds having different structures may be used in combination.

The content rate of the compound (cl) in the composition for forming an anti-scratch layer with respect to the total solid content in the composition for forming an anti-scratch layer is preferably 80% by mass or more, more preferably 85% by mass or more, and even more preferably 90% by mass or more.

(Radical Polymerization Initiator)

It is preferable that the composition for forming an anti-scratch layer contain a radical polymerization initiator.

Only one radical polymerization initiator may be used, or two or more radical polymerization initiators having different structures may be used in combination. Furthermore, the radical polymerization initiator may be a photopolymerization initiator or a thermal polymerization initiator.

The content rate of the radical polymerization initiator in the composition for forming an anti-scratch layer is not particularly limited. For example, the content rate with respect to 100 parts by mass of the compound (cl) is preferably 0.1 to 200 parts by mass, and more preferably 1 to 50 parts by mass.

(Solvent)

The composition for forming an anti-scratch layer may contain a solvent.

This solvent is the same as the solvent that may be contained in the aforementioned composition for forming a hardcoat layer.

The content rate of the solvent in the composition for forming an anti-scratch layer can be appropriately adjusted within a range in which the coating suitability of the composition for forming an anti-scratch layer can be ensured. For example, the content rate of the solvent with respect to the total solid content, 100 parts by mass, of the composition for forming an anti-scratch layer can be 50 to 500 parts by mass, and preferably 80 to 200 parts by mass.

The composition for forming an anti-scratch layer is generally in the form of a liquid.

The concentration of solid contents of the composition for forming an anti-scratch layer is generally about 10% to 90% by mass, preferably about 20% to 80% by mass, and particularly preferably about 40% to 70% by mass.

(Other Additives)

The composition for forming an anti-scratch layer may contain components other than the above, for example, inorganic particles, a leveling agent, an antifouling agent, an antistatic agent, a lubricant, a solvent, and the like.

Particularly, it is preferable that the anti-scratch layer contain the following fluorine-containing compound as a lubricant.

[Fluorine-Containing Compound]

The fluorine-containing compound may be any of a monomer, an oligomer, or a polymer. It is preferable that the fluorine-containing compound have substituents that contribute to the bond formation or compatibility of the compound with the compound (ci) in the anti-scratch layer. These substituents may be the same or different from each other. It is preferable that the compound have a plurality of such substituents.

The substituents are preferably polymerizable groups, and may be polymerizable reactive groups showing any of radical polymerization properties, polycondensation properties, cationic polymerization properties, anionic polymerization properties, and addition polymerization properties. Preferable examples of the substituents include an acryloyl group, a methacryloyl group, a vinyl group, an allyl group, a cinnamoyl group, an epoxy group, an oxetanyl group, a hydroxyl group, a polyoxyalkylene group, a carboxyl group, an amino group, and the like. Among these, radically polymerizable groups are preferable, and particularly, an acryloyl group and a methacryloyl group are preferable.

The fluorine-containing compound may be a polymer or an oligomer with a compound having no fluorine atom.

The fluorine-containing compound is preferably a fluorine-based compound represented by General Formula (F).

(R^{f})—[(W)—(R^{A})_{nf}]_{mf} General Formula (F):

(In the formula, R^{f} represents a (per)fluoroalkyl group or a (per)fluoropolyether group, W represents a single bond or a linking group, and R^{A} represents a polymerizable unsaturated group. nf represents an integer of 1 to 3. mf represents an integer of 1 to 3.)

In General Formula (F), R^{A} represents a polymerizable unsaturated group. The polymerizable unsaturated group is preferably a group having an unsaturated bond capable of causing a radical polymerization reaction by being irradiated with active energy rays such as ultraviolet rays or electron beams (that is, the polymerizable unsaturated group is preferably a radically polymerizable group). Examples thereof include a (meth)acryloyl group, a (meth)acryloyloxy group, a vinyl group, an allyl group, and the like. Among these, a (meth)acryloyl group, a (meth)acryloyloxy group, and groups obtained by substituting any hydrogen atom in these groups with a fluorine atom are preferably used.

In General Formula (F), R^{f} represents a (per)fluoroalkyl group or a (per)fluoropolyether group.

The (per)fluoroalkyl group represents at least one of a fluoroalkyl group or a perfluoroalkyl group, and the (per)fluoropolyether group represents at least one of a fluoropolyether group or a perfluoropolyether group. From the viewpoint of scratch resistance, it is preferable that the fluorine content rate in R^{f} be high.

The (per)fluoroalkyl group is preferably a group having 1 to 20 carbon atoms, and more preferably a group having 1 to 10 carbon atoms.

The (per)fluoroalkyl group may be a linear structure (for example, —CF₂CF₃, —CH₂(CF₂)₄H, —CH₂(CF₂)₈CF₃, —CH₂CH₂(CF₂)₄H), a branched structure (for examples, —CH(CF₃)₂, —CH₂CF(CF₃)₂, —CH(CH₃)CF₂CF₃, —CH(CH₃)(CF₂)₅CF₂H), or an alicyclic structure (preferably a 5- or 6-membered ring, for example, a perfluorocyclohexyl group, a perfluorocyclopentyl group, and an alkyl group substituted with these groups).

The (per)fluoropolyether group refers to a (per)fluoroalkyl group having an ether bond, and may be a monovalent group or a group having a valence of 2 or more. Examples of the fluoropolyether group include —CH₂OCH₂CF₂CF₃, —CH₂CH₂OCH₂C₄F₈H, —CH₂CH₂OCH₂CH₂C₈F₁₇, —CH₂CH₂OCF₂CF₂OCF₂CF₂H, a fluorocycloalkyl group having 4 to 20 carbon atoms with four or more fluorine atoms, and the like. Examples of the perfluoropolyether group include-(CF₂O)_{pf}—(CF₂CF₂O)_{qf}—,—[CF(CF₃)CF₂O]_{pf}—[CF(CF₃)]_{qf}—, —(CF₂CF₂CF₂O)_{pf}—, —(CF₂CF₂O)_{pf}—, and the like.

pf and qf each independently represent an integer of 0 to 20. Here, pf+qf is an integer of 1 or more.

The sum of pf and qf is preferably 1 to 83, more preferably 1 to 43, and even more preferably 5 to 23.

From the viewpoint of excellent scratch resistance, the fluorine-containing compound particularly preferably has a perfluoropolyether group represented by —(CF₂O)_{pf}—(CF₂CF₂O)_{qf}.

In the present invention, the fluorine-containing compound preferably has a perfluoropolyether group and has a plurality of polymerizable unsaturated groups in one molecule.

In General Formula (F), W represents a linking group. Examples of W include an alkylene group, an arylene group, a heteroalkylene group, and a linking group obtained by combining these groups. These linking groups may further have an oxy group, a carbonyl group, a carbonyloxy group, a carbonylimino group, a sulfonamide group, and a functional group obtained by combining these groups.

W is preferably an ethylene group, and more preferably an ethylene group bonded to a carbonylimino group.

The content of fluorine atoms in the fluorine-containing compound is not particularly limited, but is preferably 20% by mass or more, more preferably 30% to 70% by mass, and even more preferably 40% to 70% by mass.

Preferable examples of the fluorine-containing compound include R-2020, M-2020, R-3833, M-3833, and OPTOOL DAC (trade names) manufactured by DAIKIN INDUSTRIES, LTD, and MEGAFACE F-171 F-172, F-179A, RS-78, RS-90, and DEFENSA MCF-300 and MCF-323 (trade names) manufactured by DIC Corporation, but the fluorine-containing compound is not limited to these.

From the viewpoint of scratch resistance, in General Formula (F), the product of nf and mf (nf×mf) is preferably 2 or more, and more preferably 4 or more.

The weight-average molecular weight (Mw) of the fluorine-containing compound having a polymerizable unsaturated group can be measured using molecular exclusion chromatography, for example, gel permeation chromatography (GPC).

Mw of the fluorine-containing compound used in the present invention is preferably 400 or more and less than 50,000, more preferably 400 or more and less than 30,000, and even more preferably 400 or more and less than 25,000.

The content rate of the fluorine-containing compound with respect to the total solid content in the composition for forming an anti-scratch layer is preferably 0.01% to 5% by mass, more preferably 0.1% to 5% by mass, even more preferably 0.5% to 5% by mass, and particularly preferably 0.5% to 2% by mass.

The composition for forming an anti-scratch layer used in the present invention can be prepared by simultaneously mixing together the various components described above or sequentially mixing together the various components described above in any order. The preparation method is not particularly limited, and the composition can be prepared using a known stirrer or the like.

The anti-scratch layer preferably contains a cured product of the composition for forming an anti-scratch layer containing the compound (cl), and more preferably contains a cured product of the composition for forming an anti-scratch layer containing the compound (c1) and a radical polymerization initiator.

The cured product of the composition for forming an anti-scratch layer preferably contains at least a cured product obtained by the polymerization reaction of the radically polymerizable group of the compound (ci).

In the anti-scratch layer, the content rate of the cured product of the composition for forming an anti-scratch layer with respect to the total mass of the anti-scratch layer is preferably 60% by mass or more, more preferably 70% by mass or more, and even more preferably 80% by mass or more.

<Pencil Hardness>

The hardcoat film according to an embodiment of the present invention is excellent in pencil hardness.

The pencil hardness of the hardcoat film according to an embodiment of the present invention is preferably 4H or more, and more preferably 5H or more.

The pencil hardness can be evaluated according to JIS K 5600-5-4 (1999).

<Resistance to Repeated Folding>

The hardcoat film according to an embodiment of the present invention is excellent in resistance to repeated folding.

Particularly, in a case where a hardcoat film is folded with a substrate facing inwards (hardcoat layer facing outwards), the hardcoat layer easily cracks, which is a technical problem very difficult to solve.

It is preferable that no crack occur in the hardcoat layer of the hardcoat film according to an embodiment of the present invention, in a case where a 1800 folding test is repeated 300,000 times on the hardcoat film with the substrate facing inwards at a curvature radius of 1 mm.

Specifically, the resistance to repeated folding is measured as follows.

A sample film having a width of 15 mm and a length of 150 mm is cut out from the hardcoat film, and left to stand for 1 hour or more in an environment at a temperature of 25° C. and a relative humidity of 60%. Then, by using a 180° folding resistance tester (IMC-0755 manufactured by Imoto Machinery Co., Ltd.), the sample film with the hardcoat layer (or the hardcoat layer with an anti-scratch layer) facing outwards (the substrate facing inwards) is tested for resistance to repeated folding. In the tester, the sample film is aligned with the curved surface of a rod (cylinder) having a diameter of 2 mm, folded at the central portion in the longitudinal direction at a bending angle of 180°, and then restored to its original condition (the sample film is unfolded). This operation is regarded as a single test, and the test is repeated.

<Method for Manufacturing Hardcoat Film>

The method for manufacturing a hardcoat film according to an embodiment of the present invention will be described.

The hardcoat film according to an embodiment of the present invention is preferably a manufacturing method including the following steps (1) and (II). In a case where the hardcoat film has an anti-scratch layer, it is preferable that the manufacturing method additionally include the following steps (III) and (IV).

(I) A step of coating a substrate with a composition for forming a hardcoat layer to form a hardcoat layer coating film

(II) A step of curing the hardcoat layer coating film to form a hardcoat layer

(III) A step of coating the hardcoat layer with a composition for forming an anti-scratch layer to form an anti-scratch layer coating film

(IV) A Step of curing the anti-scratch layer coating film to form an anti-scratch layer —Step (I)—

Step (I) is a step of coating a substrate with a composition for forming a hardcoat layer to form a hardcoat layer coating film.

The substrate and the composition for forming a hardcoat layer are as described above.

As the method of coating the substrate with the composition for forming a hardcoat layer, known methods can be used without particular limitation. Examples thereof include a dip coating method, an air knife coating method, a curtain coating method, a roller coating method, a wire bar coating method, a gravure coating method, a die coating method, and the like. —Step (II)—

Step (II) is a step of curing the hardcoat layer coating film to form a hardcoat layer. Curing the hardcoat layer coating film means that at least some of the crosslinkable groups of the curable compound (preferably the polyorganosilsesquioxane (a1)) contained in the hardcoat layer coating film have a polymerization reaction.

The curing of the hardcoat layer coating film is preferably performed by the irradiation with ionizing radiation or heating.

The type of ionizing radiation is not particularly limited, and examples thereof include X-rays, electron beams, ultraviolet rays, visible light, infrared, and the like. Among these, ultraviolet rays are preferably used. For example, in a case where the hardcoat layer coating film can be cured by ultraviolet rays, it is preferable to irradiate the coating film with ultraviolet rays from an ultraviolet lamp at an irradiation dose of 10 mJ/cm² to 2,000 mi/cm² so that the curable compound is cured. In a case where the hardcoat film has an anti-scratch layer on the hardcoat layer, it is preferable to semi-cure the curable compound. The irradiation dose is more preferably 50 mJ/cm² to 1,800 mJ/cm², and even more preferably 100 mJ/cm² to 1,500 mJ/cm². As the ultraviolet lamp, a metal halide lamp, a high-pressure mercury lamp, or the like is suitably used.

In a case where the coating film is cured by heat, the temperature is not particularly limited, but is preferably 80° C. or higher and 200° C. or lower, more preferably 100° C. or higher and 180° C. or lower, and even more preferably 120° C. or higher and 160° C. or lower.

The oxygen concentration during curing is preferably 0% to 1.0% by volume, more preferably 0% to 0.1% by volume, and most preferably 0% to 0.05% by volume. —Step (III)—

Step (III) is a step of coating the hardcoat layer with a composition for forming an anti-scratch layer to form an anti-scratch layer coating film.

The composition for forming an anti-scratch layer is as described above.

As the method of coating the hardcoat layer with the composition for forming an anti-scratch layer, known methods can be used without particular limitation. Examples thereof include a dip coating method, an air knife coating method, a curtain coating method, a roller coating method, a wire bar coating method, a gravure coating method, a die coating method, and the like. —Step (IV)—

Step (IV) is a step of curing the anti-scratch layer coating film to form an anti-scratch layer.

The curing of the anti-scratch layer coating film is preferably performed by the irradiation with ionizing radiation or heating. The irradiation with ionizing radiation and heating are the same as those described in Step (II). Curing the anti-scratch layer coating film means that at least some of the polymerizable groups of the curable compound (preferably the radically polymerizable compound (cl)) contained in the anti-scratch layer coating film have a polymerization reaction.

In the present invention, in a case where the hardcoat film has an anti-scratch layer on the hardcoat layer, it is preferable that the hardcoat layer coating film be semi-cured in Step (II). That is, the hardcoat layer coating film is preferably semi-cured in Step (II), the semi-cured hardcoat layer is then preferably coated with the composition for forming an anti-scratch layer in Step (III) so that an anti-scratch layer coating film is formed, and then the anti-scratch layer coating film is preferably cured and the hardcoat layer is preferably fully cured in Step (IV) so that the interfacial adhesion between the hardcoat layer and the anti-scratch layer is more sufficiently promoted. Semi-curing the hardcoat layer coating film means that at least some of the crosslinkable groups of the polyorganosilsesquioxane (a1) contained in the hardcoat layer coating film have a polymerization reaction. The semi-curing of the hardcoat layer coating film can be performed by controlling the irradiation dose of ionizing radiation or the heating temperature and time.

If necessary, a drying treatment may be performed between Step (I) and Step (II), between Step (II) and Step (III), between Step (III) and Step (iv), or after Step (IV). The drying treatment can be performed by blowing hot air, disposing the film in a heating furnace, transporting the film in a heating furnace, heating a surface (substrate surface) of the film not provided with the hardcoat layer and the anti-scratch layer with a roller, and the like. The heating temperature is not particularly limited and may be set to a temperature at which the solvent can be dried and removed. The heating temperature means the temperature of hot air or the internal atmospheric temperature of the heating furnace.

The hardcoat film according to an embodiment of the present invention is excellent in pencil hardness and resistance to repeated folding. Furthermore, the hardcoat film according to an embodiment of the present invention can be used as a surface protection film of an image display device. For example, the hardcoat film can be used as a surface protection film of a foldable device (foldable display). The foldable device is a device that employs a flexible display having a deformable display screen. The body (display) of the device can be folded by utilizing the deformability of the display screen.

Examples of the foldable device include an organic electroluminescence device and the like.

The present invention also relates to an article comprising the hardcoat film according to an embodiment of the present invention, and an image display device comprising the hardcoat film according to an embodiment of the present invention as a surface protection film.

As described above, the hardcoat film according to an embodiment of the present invention may have an adhesive layer.

(Adhesive Layer)

The adhesive layer is a layer provided for sticking the hardcoat layer and the substrate together.

As the adhesive constituting the adhesive layer, any of appropriate forms of adhesives can be adopted. Specific examples thereof include a water-based adhesive, a solvent-based adhesive, an emulsion-based adhesive, a solvent-free adhesive, an active energy ray-curable adhesive, and a thermosetting adhesive. Examples of the active energy ray-curable adhesive include an electron beam-curable adhesive, an ultraviolet-curable adhesive, and a visible light-curable adhesive. Among the above, a water-based adhesive and an active energy ray-curable adhesive can be suitably used. Specific examples of the water-based adhesive include an isocyanate-based adhesive, a polyvinyl alcohol-based adhesive (PVA-based adhesive), a gelatin-based adhesive, a vinyl-based adhesive, a latex-based adhesive, water-based polyurethane, and water-based polyester. Specific examples of the active energy ray-curable adhesive include a (meth)acrylate-based adhesive. Examples of curable components in the (meth)acrylate-based adhesive include a compound having a (meth)acryloyl group and a compound having a vinyl group. As a cationic polymerization-curable adhesive, a compound having an epoxy group or an oxetanyl group can also be used. The compound having an epoxy group is not particularly limited as long as it has at least two epoxy groups in a molecule. Various generally known curable epoxy compounds can be used as this compound. As the epoxy compounds, for example, a compound having at least two epoxy groups and at least one aromatic ring in a molecule (aromatic epoxy compound), a compound which has at least two epoxy groups in a molecule and in which at least one of the epoxy groups is formed between two adjacent carbon atoms constituting an alicyclic ring (alicyclic epoxy compound), and the like are preferable. Specific examples of the thermosetting adhesive include a phenol resin, an epoxy resin, a polyurethane-type curable resin, a urea resin, a melamine resin, an acrylic reactive resin, and the like. Specific examples thereof include bisphenol F-type epoxide.

In one embodiment, as the adhesive constituting the aforementioned adhesive layer, a PVA-based adhesive is used. In a case where the PVA-based adhesive is used, even though materials that do not transmit active energy rays are used, it is possible to stick the materials together. In another embodiment, as the adhesive constituting the aforementioned adhesive layer, an active energy ray-curable adhesive is used. In a case where the active energy ray-curable adhesive is used, even a material which has a hydrophobic surface and is unstickable with a PVA adhesive can obtain sufficient delamination force.

Specific examples of the adhesive include an adhesive described in JP2004-245925A that contains an epoxy compound having no aromatic ring in a molecule and is cured by heating or active energy ray irradiation, an active energy ray-curable adhesive described in JP2008-174667A that contains (a) (meth)acrylic compound having two or more (meth)acryloyl groups in a molecule. (b) (meth)acrylic compound having a hydroxyl group in a molecule and having only one polymerizable double bond, and (c) phenol ethylene oxide-modified acrylate or nonylphenol ethylene oxide-modified acrylate in a total of 100 parts by mass of the (meth)acrylic compound, and the like.

In a range of 70° C. or lower, the storage modulus of the adhesive layer is preferably 1.0×10⁶ Pa or more, and more preferably 1.0×10⁷ Pa or more. The upper limit of the storage modulus of the adhesive layer is, for example, 1.0×10¹⁰ Pa.

Typically, the thickness of the adhesive layer is preferably 0.01 μm to 7 μm, and more preferably 0.01 μm to 5 μm.

Being positioned between the hardcoat layer and the substrate, the adhesive layer greatly affects hardness. Therefore, In a case where a pressure sensitive adhesive is used instead of the adhesive layer, sometimes hardness is significantly reduced. From the viewpoint of the hardness, it is preferable that the adhesive layer be thin and have a high storage modulus.

For the active energy ray-curable adhesive, the choice of initiator or photosensitizer is also important. Specifically, the (meth)acrylate-based adhesive is described, for example, in Examples of JP2018-17996A. The cationic polymerization-curable adhesive can be prepared with reference to the descriptions in JP2018-35361 A and JP2018-41079A.

It is preferable that the PVA-based adhesive contain an additive that improves the adhesiveness to the substrate or the hardcoat layer. The type of additive is not particularly limited, but it is preferable to use a compound containing, for example, boronic acid, or the like.

From the viewpoint of inhibiting interference fringes, a difference in a refractive index between the adhesive layer and the hardcoat layer is preferably 0.05 or less, and more preferably 0.02 or less. The method of adjusting the refractive index of the adhesive is not particularly limited. In order to reduce the refractive index, it is preferable to add hollow particles. In order to increase the refractive index, it is preferable to add zirconia particles or the like. More specifically, for example, JP2018-17996A describes specific examples of adhesives having a refractive index of 1.52 to 1.64.

From the viewpoint of the photocoloration resistance of the hardcoat film, it is preferable to incorporate an ultraviolet absorber into the adhesive layer. In a case where an ultraviolet absorber is added to the adhesive layer, from the viewpoint of bleed out or curing inhibition, it is preferable to add the ultraviolet absorber to a thermosetting adhesive.

(Ultraviolet Absorber)

Examples of the ultraviolet absorber include a benzotriazole compound, a triazine compound, and a benzoxazine compound. The benzotriazole compound is a compound having a benzotriazole ring, and specific examples thereof include various benzotriazole-based ultraviolet absorbers described in paragraph “0033” of JP2013-111835A. The triazine compound is a compound having a triazine ring, and specific examples thereof include various triazine-based ultraviolet absorbers described in paragraph “0033” of JP2013-111835A. As the benzoxazine compound, for example, those described in paragraph “0031” of JP2014-209162A can be used. The content of the ultraviolet absorber in the adhesive layer is, for example, about 0.1 to 10 parts by mass with respect to 100 parts by mass of the polymer contained in the adhesive, but is not particularly limited. Regarding the ultraviolet absorber, paragraph “0032” of JP2013-111835A can also be referred to. In the present invention, an ultraviolet absorber having high heat resistance and low volatility is preferable. Examples of such an ultraviolet absorber include UVSORB101 (manufactured by FUJIFILM Wako Pure Chemical Corporation), TINUVIN 360, TINUVIN 460, and TINUVIN 1577 (manufactured by BASF SE), LA-F70, LA-31, and LA-46 (manufactured by ADEKA CORPORATION), and the like.

From the viewpoint of forming the mixed layer which will be described later, the adhesive preferably contains a compound having a molecular weight of 500 or less, and more preferably contains a compound having a molecular weight of 300 or less. Furthermore, from the same viewpoint, the adhesive preferably contains a component having an SP value of 21 to 26. The SP value (solubility parameter) in the present invention is a value calculated by Hoy's method. The Hoy's method is described in POLYMERHANDBOOK FOURTH EDITION.

From the viewpoint of forming the mixed layer which will be described later, it is preferable that the adhesive for forming the adhesive layer have high affinity with the substrate. The affinity between the substrate and the adhesive can be checked by observing the change of the substrate shown in a case where the substrate is immersed in the adhesive. It is preferable to use an adhesive in which the substrate turns cloudy or is dissolved in a case where the substrate is immersed in the adhesive, because such an adhesive can effectively form the mixed layer which will be described later.

(Mixed Layer)

In a case where the hardcoat film according to an embodiment of the present invention has the adhesive layer described above, it is preferable that a mixed layer in which components of the adhesive and components of the substrate are mixed together be formed between the adhesive layer and the substrate layer.

The mixed layer refers to a region between the adhesive layer and the substrate, in which the compound distribution (components of the adhesive layer and components of the substrate) gradually changes from the adhesive layer side to the substrate layer side. In this case, the adhesive layer refers to a portion which contains only the components of the adhesive layer and does not contain the components of the substrate, and the substrate refers to a portion which does not contain the components of the adhesive layer. In a case where the film is cut with a microtome, and the cross section is analyzed using a time-of-flight secondary ion mass spectrometer (TOF-SIMS), a portion is found where the components of both the substrate and adhesive layer are detected, and this portion can be measured as the mixed layer. The film thickness of this region can also be measured from the information on the cross section obtained using TOF-SIMS.

The thickness of the mixed layer is preferably 0.1 to 10.0 μm, and more preferably 1.0 μm to 6.0 μm. It is preferable that the thickness of the mixed layer be 0.1 μm or more, because then lightfast adhesion (adhesion between the hardcoat layer and the substrate after ultraviolet irradiation) is effectively improved, and the lightfast adhesion between the hardcoat layer and the substrate can remain excellent even in a case where ultraviolet irradiation is performed for a long period time. It is preferable that the thickness of the mixed layer be 10 μm or less, because then excellent hardness is obtained. Furthermore, it is more preferable that the thickness of the mixed layer be 6.0 μm or less, because then excellent hardness can be maintained.

[Method for Manufacturing Hardcoat Film Having Adhesive Layer (Transfer Method)]

The method for manufacturing a hardcoat film having an adhesive layer will be described.

The method for manufacturing a hardcoat film having an adhesive layer according to an embodiment of the present invention is not particularly limited. For example, one of the preferred aspects thereof is a method of forming at least one hardcoat layer on a temporary support and then transferring the hardcoat laver to a substrate from the temporary support via an adhesive layer (aspect A). Another preferred aspect is, for example, a method of forming at least one hardcoat layer on a temporary support, then transferring the hardcoat layer to a protective film from the temporary support, and then transferring the hardcoat layer to a substrate from the protective film via an adhesive layer (aspect B).

Hereinafter, Aspect A will be specifically described. Specifically, Aspect A is preferably a manufacturing method including Steps (1), (2), (4), and (5), and more preferably a manufacturing method including Steps (1), (2), (3), (4), and (5). Although Step (3) may not be carried out, it is preferable to perform this step because in a case where the substrate is impregnated with a part of the adhesive layer, the lightfast adhesiveness of the hardcoat film can be improved.

Step (1): A step of coating a temporary support with a composition for forming a hardcoat layer, drying the composition, and then curing the composition so that at least one hardcoat layer is formed.

Step (2): A step of laminating a substrate on a side of the hardcoat layer that is opposite to the temporary support via an adhesive

Step (3): A step of impregnating the substrate with a part of the adhesive

Step (4): A step of performing heating or active energy ray irradiation so that the hardcoat layer and the substrate stick together

Step (5): A step of peeling the temporary support from the hardcoat layer

<Step (1)>

Step (1) is a step of coating a temporary support with a composition for forming a hardcoat layer, drying the composition, and then curing the composition so that at least one hardcoat layer is formed. Step (1) is the same step as Step (I) and Step (II) except that the substrate is replaced with a temporary support.

(Temporary Support)

The temporary support is not particularly limited as long as it has a smooth surface. It is preferable that the temporary support have a flat surface having a surface roughness of about 30 nm or less and be not difficult to be coated with the composition for forming a hardcoat layer. Temporary supports consisting of various materials can be used. For example, a polyethylene terephthalate (PET) film or a cycloolefin-based resin film is preferably used.

In the present invention, the surface roughness is measured using SPA-400 (manufactured by Hitachi High-Tech Science Corporation.) under the measurement conditions of a measurement range of 5 μm×5 μm, a measurement mode: DFM, and a measurement frequency: 2 Hz.

<Step (2)>

Step (2) is a step of laminating a substrate on a side of the hardcoat layer that is opposite to the temporary support via an adhesive.

The adhesive used is as described above. The method of providing the adhesive layer is not particularly limited. For example, it is possible to use a method of passing the film obtained by Step (1) between nip rollers while injecting an adhesive into the space between the substrate and the side of the hardcoat layer that is opposite to the temporary support so that an adhesive layer having a uniform thickness is provided, a method of uniformly coating the substrate or the side of the hardcoat layer that is opposite to the temporary support with an adhesive and then bonding another film thereto, and the like.

(Surface Treatment)

If necessary, it is preferable to perform a surface treatment on the side of the hardcoat layer that is opposite to the temporary support or on the surface of the substrate before Step (2) is performed.

Examples of the surface treatment performed in this case include a method of modifying the film surface by a corona discharge treatment, a glow discharge treatment, an ultraviolet irradiation treatment, a flame treatment, an ozone treatment, an acid treatment, an alkali treatment, or the like. The aforementioned glow discharge treatment may be a treatment with a low-temperature plasma generated in a gas at a low pressure ranging from 10⁻³ to 20 Torr. As the glow discharge treatment, a plasma treatment under atmospheric pressure is also preferable. A plasma-excited gas refers to a gas that is plasma-excited under the above conditions. Examples thereof include fluorocarbons such as argon, helium, neon, krypton, xenon, nitrogen, carbon dioxide, and tetrafluoromethane, mixtures of these, and the like. Details of these are described on pages 30 to 32 of Journal of Technical Disclosure No. 2001-1745 of Japan Institute of Invention and Innovation (issued on Mar. 15, 2001, Japan Institute of Invention and Innovation), and can be preferably used in the present invention. Among these treatments, a plasma treatment and a corona discharge treatment are preferable, 1 Torr equals 101,325/760 Pa.

<Step (3)>

Step (3) is a step of impregnating the substrate with a part of the adhesive. Although Step (3) may not be carried out, it is preferable to perform this step because in a case where the substrate is impregnated with a part of the adhesive layer, the lightfast adhesion of the hardcoat film can be improved. How easily the substrate is impregnated with the adhesive in Step (3) varies with the type of substrate used. Therefore, the ease of impregnation can be appropriately adjusted by the components of the adhesive and the process. For example, the mixed layer can be adjusted by the process by means of controlling the temperature and time of Step (3). The longer the time of Step (3) and the higher the temperature, the further the impregnation of the substrate with the adhesive layer can be facilitated. The temperature and time of Step (3) are not particularly limited. For example, the temperature is 30° C. to 200° C. (preferably 40° C. to 150° C.). Furthermore, the time is, for example, 30 seconds to 5 minutes (preferably 1 minute to 4 minutes).

<Step (4)>

Step (4) is a step of performing heating or active energy ray irradiation so that the hardcoat layer and the substrate stick together.

The method of sticking the hardcoat layer and the substrate together is not particularly limited, and can be appropriately changed depending on the components of the adhesive layer used. Examples of the method include removing solvents (water, an alcohol, and the like) by heating in a case where the adhesive layer is a polyvinyl alcohol-based adhesive, active energy ray irradiation in a case where the adhesive layer is an active energy ray-curable adhesive, and thermal curing by heating in a case where the adhesive layer is a thermosetting adhesive. The type of active energy rays is not particularly limited, and examples thereof include X-rays, electron beams, ultraviolet rays, visible light, infrared, and the like. Among these, ultraviolet rays are preferably used. The surface to be irradiated with the active energy rays in Step (4) is not particularly limited, and can be determined depending on the transmittance of the active energy rays used in each member. The curing conditions for the ultraviolet curing are the same as the hardcoat layer curing conditions described above.

<Step (5)>

Step (5) is a step of peeling the temporary support from the hardcoat layer.

The peeling force applied to peel the temporary support from the hardcoat layer in Step (5) can be quantified by cutting the laminate obtained in Step (4) in a width of 25 mm, fixing the substrate side of the laminate to a glass substrate by using a pressure sensitive adhesive, and measuring the peeling force applied to peel off the laminate at a speed of 300 mm/min at an angle of 90°. The peeling force measured by the above method is preferably 0.1 N/25 mm to 10.0 N/25 mm, and more preferably 0.2 N/25 mm to 8.0 N/25 mm. In a case where the peeling force is 0.1 N/25 mm or more, the hardcoat layer is unlikely to be peeled from the temporary support in steps other than Step (5). Therefore, troubles are unlikely to occur. On the other hand, in a case where the peeling force is 10.0 N/25 mm or less, the hardcoat layer is unlikely to partially remain on the temporary support in Step (5), or the adhesive layer is unlikely to be peeled off. Therefore, defects are unlikely to occur. The peeling force between the temporary support and the hardcoat layer varies with the type of temporary support or hardcoat layer used. Therefore, the peeling force can be appropriately adjusted. For example, the peeling force is adjusted by a method of using a temporary support having undergone a release treatment, a method adding a peeling-facilitating compound to the composition for forming a hardcoat layer, or the like. Specific examples of the peeling-facilitating compound include a compound having a long-chain alkyl group, a fluorine-containing compound, a silicone-containing compound, and the like.

(Surface Treatment)

After Step (5), a surface treatment may be performed on a surface of the hardcoat layer that is opposite to the substrate. The type of surface treatment is not particularly limited, and examples thereof include treatments for imparting antifouling properties, fingerprint resistance, and lubricity.

In Aspect A described above, during the formation of the hardcoat layer, the temporary support is in a portion that will be the uppermost surface of the hardcoat layer. Therefore, sometimes the aforementioned fluorine-containing compound or a leveling agent cannot be sufficiently localized on the uppermost surface. In this case, it is preferable to perform the above treatment, because then water repellency and scratch resistance required for the hardcoat layer surface can be imparted.

Hereinafter, the aforementioned Aspect B will be specifically described. Specifically, Aspect B is preferably a manufacturing method including the following Steps (1′), (A) to (B), (2′), (4′), and (5′), and more preferably a manufacturing method including the following steps (1′), (A) to (B), (2′), (3′), (4′), and (5′).

Step (1′): a step of coating a temporary support with a composition for forming a hardcoat layer, drying the composition, and then curing the composition so that at least one hardcoat layer is formed.

Step (A): a step of bonding a protective film to a side of the hardcoat layer that is opposite to the temporary support

Step (B): a step of peeling the temporary support from the hardcoat laver

Step (2′): a step of laminating a film substrate containing a polyimide resin, a polyamide imide resin, or an aramid resin on a side of the hardcoat layer that is opposite to the protective film via an adhesive

Step (3′): a step of impregnating the substrate with a part of the adhesive layer

Step (4′): a step of performing heating or active energy ray irradiation so that the hardcoat layer and the film substrate stick together

Step (5′): a step of peeling the protective film from the hardcoat layer

<Step (1′)>

Step (1′) is the same step as Step (1) of Aspect A. In Step (1′), in a case where the hardcoat film includes two or more hardcoat layers or in a case where the hardcoat film includes other layers described above in addition to the hardcoat layer, the specific constitution thereof is not particularly limited as in Step (1). However, in Step (1′), from the viewpoint of scratch resistance, it is preferable that an anti-scratch layer be laminated at the end.

<Step (A)>

Step (A) is a step of bonding a protective film on a side of the hardcoat layer that is opposite to the temporary support. The protective film refers to a laminate composed of support/pressure sensitive adhesive layer. It is preferable that the pressure sensitive adhesive layer side of the protective film be bonded to the hardcoat layer. The protective film can be obtained by peeling a release film from a protective film with a release film consisting of support/pressure sensitive adhesive layer/release film. As the protective film with a release film, commercially available protective films with a release film can be suitably used. Specifically, examples thereof include AS3-304, AS3-305, AS3-306, AS3-307, AS3-310, AS3-0421, AS3-0520, AS3-0620, LBO-307, NBO-0424, ZBO-0421, S-362, and TFB-4T3-367AS manufactured by FUJIMORI KOGYO CO., LTD., and the like.

<Step (B)>

Step (B) is a step of peeling the temporary support from the hardcoat layer.

In order to peel the temporary support from the hardcoat layer, the adhesion force between the protective film and the hardcoat layer needs to be higher than the peeling force between the temporary support and the hardcoat layer. The method of adjusting the peeling force between the temporary support and the hardcoat layer is not particularly limited. For example, by a method of using a temporary support having undergone a release treatment, the peeling force between the temporary support and the hardcoat layer can be reduced. The method of adjusting the adhesion force between the protective film and the hardcoat laver is not particularly limited. Examples thereof include a method of bonding a protective film to a semi-cured hardcoat layer in Step (A) and then curing the hardcoat layer.

<Step (2′)>

Step (2′) is the same step as Step (2) of Aspect A, except that the temporary support is replaced with a protective film.

<Step (3′)>

Step (3′) is the same step as Step (3) of Aspect A.

<Step (4′)>

Step (4′) is the same step as Step (4) of Aspect A, except that the temporary support is replaced with a protective film.

<Step (5′)>

Step (5′) is the same step as Step (5) of Aspect A, except that the temporary support is replaced with a protective film.

Although Aspect B includes more steps than Aspect A, the temporary support is not on the uppermost surface of the hardcoat layer during the formation of the hardcoat layer in Aspect B. Therefore, Aspect B has advantages such as ease of localizing the aforementioned fluorine-containing compound or leveling agent on the uppermost surface and ease of imparting water repellency or scratch resistance required for the hardcoat layer surface. In Aspect B, in a case where the water repellency and scratch resistance are insufficient, after Step (5), the same surface treatment as that in Aspect A may also be performed on a surface of the hardcoat layer that is opposite to the substrate.

### EXAMPLES

Hereinafter, the present invention will be more specifically described using examples, but the scope of the present invention is not limited thereto.

<Preparation of Substrate>

(Manufacturing of Polyimide Powder)

Under a nitrogen stream, 832 g of N,N-dimethylacetamide (DMAc) was added to a 1 L reactor equipped with a stirrer, a nitrogen injection device, a dropping funnel, a temperature controller, and a cooler, and then the temperature of the reactor was set to 25° C. Bistrifluoromethylbenzidine (TFDB) (64.046 g (0.2 mol)) was added thereto and dissolved. The obtained solution was kept at 25° C., and in this state, 31.09 g (0.07 mol) of 2,2-bis(3,4-dicarboxyphenyl)hexafluoropropane dianhydride (6FDA) and 8.83 g (0.03 mol) of biphenyltetracarboxylic dianhydride (BPDA) were added thereto, and the mixture was allowed to react by being stirred for a certain period of time. Then, 20.302 g (0.1 mol) of terephthaloyl chloride (TPC) was added thereto, thereby obtaining a polyamic acid solution with a concentration of solid contents of 13% by mass. Thereafter, 25.6 g of pyridine and 33.1 g of acetic anhydride were added to the polyamic acid solution, and the mixture was stirred for 30 minutes, further stirred at 70° C. for 1 hour, and then cooled to room temperature. Methanol (20 L) was added thereto, and the precipitated solid contents were filtered and ground. Subsequently, the ground resultant was dried in a vacuum at 100° C. for 6 hours, thereby obtaining 111 g of polyimide powder.

(Preparation of Substrate S-1)

The aforementioned polyimide powder (100 g) was dissolved in 670 g of N,N-dimethylacetamide (DMAc), thereby obtaining a 13% by mass solution. The obtained solution was cast on a stainless steel plate and dried with hot air at 130° C. for 30 minutes. Then, the film was peeled from the stainless steel plate and fixed to a frame by using pins, and the frame to which the film was fixed was put in a vacuum oven, heated for 2 hours by slowly increasing the heating temperature up to 300° C. from 100° C., and then slowly cooled. The cooled film was separated from the frame. Then, as a final heat treatment step, the film was further treated with heat for 30 minutes at 300° C., thereby obtaining a substrate S-1 having a film thickness of 30 μm consisting of a polyimide film.

A substrate S-2 having a thickness of 50 μm consisting of a polyimide film, a substrate S-3 having a thickness of 15 μm consisting of a polyimide film, and a substrate S-4 having a thickness of 80 μm consisting of a polyimide film were prepared in the same manner as in the preparation of the substrate S-1.

(Synthesis of Polyorganosilsesquioxane (SQ2-1))

3-Aminopropyltrimethoxysilane (300 mmol, 53.8 g) and 166 g of methyl isobutyl ketone were mixed together, the obtained solution was cooled to a temperature of 5° C. or lower, 300 mmol (42.3 g) of 2-acryloyloxyethyl isocyanate was added dropwise thereto so that a reaction occurred, and then the temperature was raised to room temperature. Then, 300 mmol (70.0 g) of 3-(trimethoxysilyl)propyl acrylamide, 7.39 g of triethylamine, and 434 g of acetone were mixed together, and 73.9 g of pure water was added dropwise thereto for 30 minutes by using a dropping funnel. The reaction solution was heated to 50° C., and a polycondensation reaction was carried out for 10 hours.

Subsequently, the reaction solution was cooled and neutralized with 12 mL of a 1 mol/L aqueous hydrochloric acid solution, 600 g of 1-methoxy-2-propanol was added thereto, and then the mixture was concentrated under the conditions of 30 mmHg and 50° C., thereby obtaining polyorganosilsesquioxane (SQ2-1) as a transparent liquid product in a propylene glycol monomethyl ether (PGME) solution having a concentration of solid contents of 35% by mass. 1 mmHg equals 101,325/760 Pa.

In the synthesis of the polyorganosilsesquioxane (SQ2-1), the amount of monomers used was changed, thereby synthesizing polyorganosilsesquioxanes (SQ2-2) and (SQ2-3) in which the molar ratio of the contents of constitutional units was changed.

Polyorganosilsesquioxanes (SQ2-4), (SQ2-5), and (SQ2-6) with changed weight-average molecular weights (Mw) were synthesized in the same manner as in the synthesis of the polyorganosilsesquioxane (SQ2-1).

(Synthesis of Polyorganosilsesquioxane (SQ3-1))

3-Isocyanatopropyltrimethoxysilane (300 mmol, 74.2 g), 166 g of methyl isobutyl ketone, and 100 mg of NEOSTANN U-600 (manufactured by NITTO KASEI CO., LTD.) were mixed together. The obtained solution was cooled to a temperature of 5° C. or lower, 300 mmol (34.8 g) of hydroxyethyl acrylate was added dropwise thereto, and the solution was stirred at 50° C. for 4 hours. Then, polyorganosilsesquioxane (SQ3-1) was synthesized in the same manner as in the synthesis of the polyorganosilsesquioxane (SQ2-1), except that 300 mmol (70.0 g) of 3-(trimethoxysilyl)propyl acrylamide was mixed with the solution.

The structure of each polymer used as the polyorganosilsesquioxane (a1) will be shown below. In the following structural formulas, “SiO_{1.5}” represents a silsesquioxane unit. In the constitutional unit of each polymer, the compositional ratio of each constitutional unit is represented by a molar ratio.

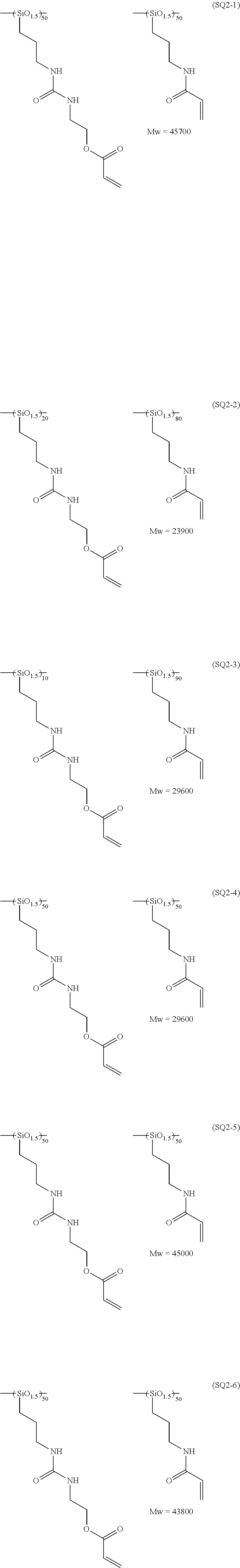

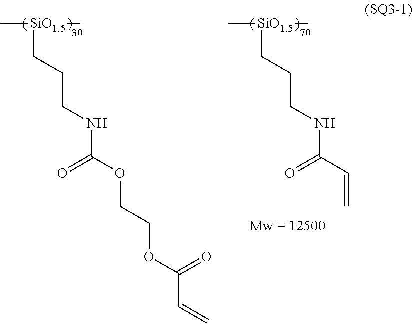

In addition, the structural formulas of the compounds used in comparative examples will be shown below.

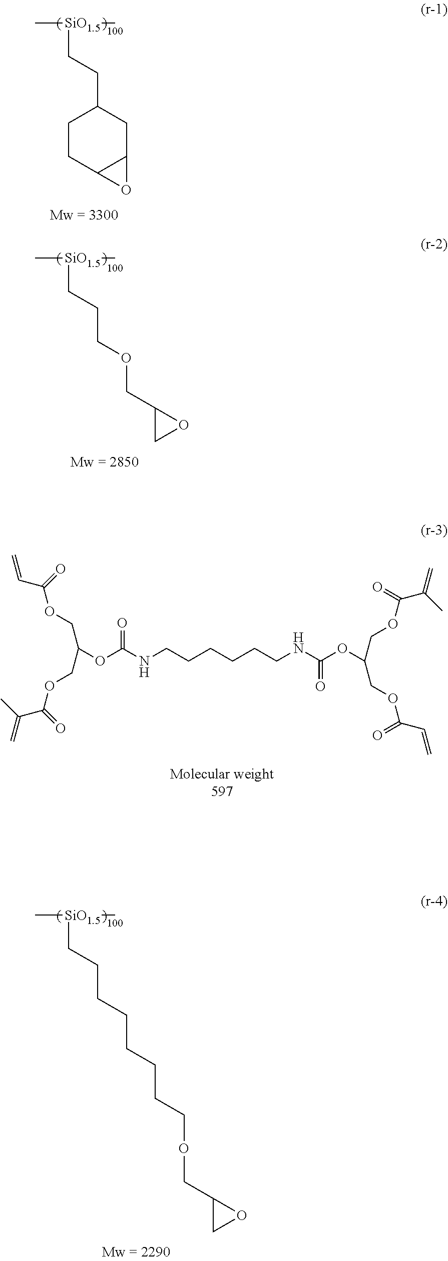

(Synthesis of (r-1))

In a 1,000 ml flask (reaction vessel) equipped with a thermometer, a stirrer, a reflux condenser, and a nitrogen introduction pipe, 300 mmol (73.9 g) of 2-(3,4-epoxycyclohexyl)ethyltrimethoxysilane, 7.39 g of triethylamine, and 370 g of methyl isobutyl ketone (MIBK) were mixed together under a nitrogen stream, and 73.9 g of pure water was added dropwise thereto for 30 minutes by using a dropping funnel. The reaction solution was heated to 80° C. so that a polycondensation reaction was carried out under a nitrogen stream for 10 hours.

Thereafter, the reaction solution was cooled, 300 g of a 5% by mass saline was added thereto, and the organic layer was extracted. The organic layer was washed with 300 g of 5% by mass saline and washed twice with 300 g of pure water in this order, and then concentrated under the conditions of 1 mmHg and 50° C., thereby obtaining 87.0 g of (r-1) which was a colorless and transparent liquid product as a MIBK solution having a concentration of solid contents of 59.8% by mass.

(Synthesis of (r-2))

(r-2) was obtained in the same manner as (r-1), except that 2-(3,4-epoxycyclohexyl)ethyltrimethoxysilane was changed to 3-glycidyloxypropyltrimethoxysilane.

(Synthesis of (r-4))

(r-4) was obtained in the same manner as (r-1), except that 2-(3,4-epoxycyclohexyl)ethyltrimethoxysilane was changed to 8-glycidyloxyoctyltrimethoxysilane.

As (r-3), U-4HA (manufactured by SHIN-NAKAMURA CHEMICAL CO, LTD.) was used.

### Example 1

(Preparation of Composition HC-1 for Forming Hardcoat Layer)

A surfactant (Z-1). IRGACURE 127, and PGME were added to a PGME solution of polyorganosilsesquioxane (SQ2-1) (concentration of solid contents: 35% by mass), and the content of each component contained in the solution was adjusted as below. The solution was put in a mixing tank and stirred. The obtained composition was filtered through a polypropylene filter having a pore size of 0.45 n, thereby obtaining a composition HC-1 for forming a hardcoat layer.

PGME solution of polyorganosilsesquioxane (SQ2-1) (concentration of solid contents: 35% by mass) 92.4 parts by mass

Surfactant (Z-1) 0.04 parts by mass

IRGACURE 127 0.9 parts by mass

PGME 6.7 parts by mass

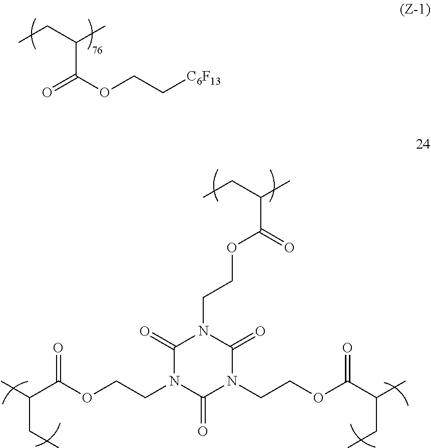

The ratio (76% and 24%) of each constitutional unit in (Z-1) is a mass ratio.

IRGACURE 127 (Irg. 127) is a radical polymerization initiator manufactured by IGM Resin B.V.

(Manufacturing of Hardcoat Film)

The polyimide substrate S-1 having a thickness of 30 μm was coated with the composition HC-1 for forming a hardcoat layer by using a #30 wire bar so that the film thickness was 14 μm after curing, thereby providing a hardcoat layer coating film on the substrate.

Thereafter, the hardcoat layer coating film was dried at 120° C. for 1 minute and then irradiated with ultraviolet rays at an illuminance of 60 mW/cm² and an irradiation dose of 600 mi/cm² by using an air-cooled mercury lamp under the conditions of 25° C. and an oxygen concentration of 100 ppm (parts per million). In this way, the hardcoat layer coating film was cured.

Thereafter, the cured hardcoat layer coating film was further irradiated with ultraviolet rays by using an air-cooled mercury lamp at an illuminance of 60 mW/cm² and an irradiation dose of 600 mJ/cm² under the conditions of 100° C. and an oxygen concentration of 100 ppm, so that the hardcoat layer coating film was fully cured, thereby forming a hardcoat layer.

### Examples 2 to 9 and Comparative Examples 1, 2, 4, and 5

Hardcoat films of Examples 2 to 9 and Comparative Examples 1, 2, 4, and 5 were manufactured in the same manner as in Example 1, except that in Example 1, the type of material (polyorganosilsesquioxane (SQ2-1)) of the hardcoat layer, the film thickness of the hardcoat layer, and the substrate were changed as described in the following Table 1.

(Preparation of Aramid Substrate (Aromatic Polyamide Substrate))

[Synthesis of Aromatic Polyamide]

N-methyl-2-pyrrolidone (674.7 kg), 10.6 g of anhydrous lithium bromide (manufactured by Sigma-Aldrich Japan K.K.), 33.3 g of 2,2′-ditrifluoromethyl-4,4′-diaminobiphenyl (“TFMB” manufactured by TORAY FINE CHEMICALS CO., LTD.), and 2.9 g of 4,4′-diaminodiphenylsulfone (“44DDS” manufactured by Wakayama Seika Co., Ltd.) were put in a polymerization tank equipped with a stirrer, cooled to 15° C. in a nitrogen atmosphere, and stirred while 18.5 g of terephthalic acid dichloride (manufactured by Tokyo Chemical Industry Co., Ltd.) and 6.4 g of 4,4′-biphenyldicarbonyl chloride (manufactured by TORAY FINE CHEMICALS CO., LTD., “4BPAC”) were being added thereto for 300 minutes in 4 divided portions. The solution was stirred for 60 minutes, and then hydrogen chloride generated by the reaction was neutralized with lithium carbonate, thereby obtaining a polymer solution.

A part of the polymer solution obtained as above was cast on an endless belt at 120° C. by using a T-die so that the final film thickness was 20 μm, and dried to a polymer concentration of 40% by mass. The film was peeled from the endless belt. Then, the film containing the solvent was stretched 1.1-fold in the machine direction (MD) in the atmosphere at 40° C., and washed with water at 50° C. so that the solvent was removed. The film was further stretched 1.2-fold in the transverse direction (TD) in a drying furnace at 340° C., thereby obtaining an aramid substrate having a thickness of 20 μm and consisting of aromatic polyamide. The aramid substrate was used as a substrate in Example 8.

### Comparative Example 3

A hardcoat film of Comparative Examples 3 was manufactured in the same manner as in Example 1, except that (r-3) was used as a material of the hardcoat layer instead of the polyorganosilsesquioxane (SQ2-1), and the film thickness of the hardcoat layer was changed as described in the following Table 1.

[Evaluation of Hardcoat Film]

The manufactured hardcoat film of each of the examples and comparative examples was evaluated by the following methods.

(Tensile Elastic Modulus)

From the manufactured hardcoat film of each of the examples and comparative examples and the substrate used in the hardcoat film, a sample (test piece) having a width of 10 mm and a length of 120 mm was cut out, and left to stand for 1 hour in an environment at a temperature of 25° C. and a relative humidity of 60%. Then, by using TENSILON RTF-1210 (A&D Company, Limited), the sample was pulled under the conditions of a tensile speed of 5 mm/sec and an inter-chuck distance (initial gauge length) of 100 mm, and the relationship between elongation and load was measured.

From the difference between the load applied in a case where each hardcoat film elongates and the load applied in a case where only the substrate elongates, the load applied only to the hardcoat layer was calculated.

The elastic modulus (E′_{(0.4)HC}) of the hardcoat layer obtained in a case where the elongation rate was 0.4% was determined by the procedures (1), (2), and (3) described above.

The elastic modulus (E′_{(4)HC}) of the hardcoat layer obtained in a case where the elongation rate was 4% was determined by the procedures (4), (5), and (6) described above.

The elastic modulus (E′_{(0.4)S}) of the substrate obtained in a case where the elongation rate was 0.4% was calculated by subtracting the stress (load÷cross-sectional area) applied in a case where the elongation rate was 0.2% from the stress (load÷cross-sectional area) applied in a case where the elongation rate was 0.4% (stress difference) and dividing the stress difference by the difference in the elongation rate (0.002).

(Film Thickness of Hardcoat Layer)

The manufactured hardcoat film of each of the examples and comparative examples was cut with a microtome to obtain a cross section, the cross section was observed with a scanning electron microscope (S-4300 manufactured by Hitachi High-Tech Corporation), and the film thickness (d_{HC}) of the hardcoat layer was calculated.

(Pencil Hardness)

The hardness of the surface of the hardcoat film on the hardcoat layer side was measured according to JIS K 5600-5-4 (1999).

(Resistance to Repeated Folding)

From the manufactured hardcoat film of each of the examples and comparative examples, a sample film having a width of 15 mm and a length of 150 mm was cut out, and left to stand for 1 hour or more in an environment at a temperature of 25° C. and a relative humidity of 60%. Then, by using a 1800 folding resistance tester (IMC-0755 manufactured by Imoto Machinery Co., Ltd.), the sample film with the hardcoat layer facing outwards (the substrate facing inwards) was tested for resistance to repeated folding. In the tester used, the sample film was aligned with the curved surface of a rod (cylinder) having a diameter of 2 mm, folded at the central portion in the longitudinal direction at a bending angle of 180°, and then restored to its original condition (the sample film is unfolded). This operation was regarded as a single test, and the test was repeated. The 180° folding test was repeated at 200 times/min. At this time, a sample film in which no crack occurred until the maximum number of times the test was repeated exceeded 300,000 was graded A, a sample film in which no crack occurred until the maximum number of times the test was repeated exceeded 200,000 and reached 300,000 was graded B, a sample film in which no crack occurred until the maximum number of times the test was repeated exceeded 100,000 and reached 200,000 was graded C, a sample film in which no crack occurred until the maximum number of times the test was repeated exceeded 50,000 and reached 100,000 was graded D, and a sample film in which no crack occurred until the maximum number of times the test was repeated reached 50,000 was graded E. Whether or not cracks occur was evaluated using an optical microscope.

TABLE 1

| | | | | Physical properties of | | | | |
|---|---|---|---|---|---|---|---|---|
| | | | | hardcoat layer | | Physical properties of | | |
| | | Hardcoat layer | | Elastic modulus (MPa) × | | hardcoat layer | Evaluation | |
| | | Material | Film | film thickness (μm) | | Elastic modulus (MPa) × | | Resistance |
| | | of | thick- | At | At | film thickness (μm) | Pencil | to |
| | Substrate | hardcoat | ness | elongation | elongation | At elongation | hard- | repeated |
| | Type | layer | (μm) | rate of 4% | rate of 4% | rate of 0.4% | ness | folding |
| Example 1 | S-1 | (SQ2-1) | 14.0 | 27,467 | 3,891 | 190,970 | 5H | C |
| Example 2 | S-1 | (SQ2-1) | 5.2 | 12,500 | 908 | 190,970 | 4H | A |
| Example 3 | S-1 | (SQ2-2) | 5.0 | 14,922 | 1,248 | 190,970 | 4H | B |
| Example 4 | S-2 | (SQ2-3) | 2.4 | 9,136 | 1,082 | 309,817 | 4H | B |
| Example 5 | S-1 | (SQ3-1) | 7.4 | 17,086 | 1,328 | 190,970 | 4H | C |
| Example 6 | S-2 | (SQ2-4) | 5.0 | 12,284 | 910 | 309,817 | 5H | B |
| Example 7 | S-3 | (SQ2-5) | 8.5 | 17,094 | 2,480 | 103,682 | 4H | C |
| Example 8 | Aramid | (SQ2-5) | 4.5 | 8,778 | 1,128 | 169,454 | 4H | A |
| Example 9 | S-4 | (SQ2-6) | 3.4 | 8,030 | 1,374 | 512,820 | 4H | C |
| Comparative | S-1 | (r-1) | 12.4 | 30,083 | 18,172 | 190,970 | 5H | E |
| Example 1 | | | | | | | | |
| Comparative | S-1 | (r-2) | 11.9 | 8,175 | 7,090 | 190,970 | 4H | D |
| Example 2 | | | | | | | | |
| Comparative | S-1 | (r-3) | 4.2 | 10,168 | 7,098 | 190,970 | 4H | D |
| Example 3 | | | | | | | | |
| Comparative | S-1 | (r-4) | 18.0 | 4,044 | 2,213 | 190,970 | 2H | A |
| Example 4 | | | | | | | | |
| Comparative | S-1 | (SQ2-3) | 0.8 | 2,242 | 490 | 190,970 | 2H | A |
| Example 5 | | | | | | | | |

As shown in Table 1, the hardcoat films of Examples 1 to 9 satisfied E′_{(0.4)HC}×d_{HC}≥8,000 MPa·μm and E′_{(4)HC}×d_{HC}≤4,000 MPa·μm, and was excellent in hardness and resistance to repeated folding. E′_{(0.4)HC} is an elastic modulus of the hardcoat layer obtained in a case where an elongation rate is 0.4%. E′_{(4)HC} is an elastic modulus of the hardcoat layer obtained in a case where an elongation rate is 4%. d_{HC} is a film thickness of the hardcoat layer.

On the other hand, in Comparative Examples 1 to 3, E′_{(4)HC}×d_{HC} was more than 4,000 MPa·μm, and the resistance to repeated folding was poorer than that in Examples 1 to 9.

Furthermore, in Comparative Examples 4 and 5, E′_{(0.4)HC}×d_{HC} was less than 8,000 MPa·μm, and the hardness was poorer than that in Examples 1 to 9.

### Example 10

(Composition SR-1 for Forming Anti-Scratch Layer)

Components composed as below were put in a mixing tank, stirred, and filtered through a polypropylene filter having a pore size of 0.4 μm, thereby obtaining a composition SR-1 for forming an anti-scratch layer.

| | |
|---|---|
| A-TMMT | 26.2 parts by mass |
| DPCA-30 | 7.1 parts by mass |
| IRGACURE 127 | 1.0 part by mass |
| Conductive compound A | 3.2 parts by mass |
| RS-90 | 3.5 parts by mass |
| Methyl ethyl ketone | 50.4 parts by mass |

The compounds used in the composition for forming an anti-scratch layer are as follows.

A-TMMT: Pentaerythritol tetraacrylate (manufactured by SHIN-NAKAMURA CHEMICAL CO, LTD.)

DPCA-30: KAYARAD DPCA-30

RS-90: Lubricant, manufactured by DIC Corporation (concentration of solid contents: 10%)

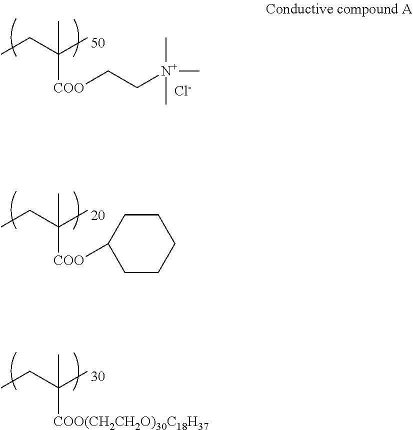

(Method for Synthesizing Conductive Compound A)

Ethanol (58.25 g) was put in a 500 ml three-neck flask equipped with a stirrer, a thermometer, a reflux condenser, and a nitrogen gas introduction pipe, and heated to 70° C. Then, a mixed solution consisting of 62.14 g (299.18 mmol) of trimethyl-2-methacloyloxyethylammonium chloride (80% aqueous solution), 20.00 g (118.88 mmol) of cyclohexyl methacrylate, 30.00 g (18.07 mmol) of BLEMMER PSE1300 (manufactured by NOF CORPORATION), 167.90 g of ethanol, and 24.50 g of azobisisobutyronitrile was added dropwise thereto at a constant rate so that the dropwise addition was finished in 3 hours. After the dropwise addition was finished, a mixed solution of 0.40 g of azobisisobutyronitrile and 19.10 g of ethanol was added thereto. The mixture was further stirred for 3 hours, then heated to 78.5° C., and then stirred again for 8 hours, thereby obtaining 360.00 g (concentration of solid contents: 28%) of a polymer ethanol solution.

(Manufacturing of Hardcoat Film)

By using a #12 wire bar, the polyimide substrate S-1 having a thickness of 30 μm was coated with a composition for forming a hardcoat layer in which polyorganosilsesquioxane (SQ2-6) was used instead of the polyorganosilsesquioxane (SQ2-1) in the composition HC-1 for forming a hardcoat layer, so that the film thickness was 4.7 μm after curing. In this way, a hardcoat layer coating film was provided on the substrate.

Thereafter, the hardcoat layer coating film was dried at 120° C. for 1 minute and then irradiated with ultraviolet rays at an illuminance of 18 mW/cm² and an irradiation dose of 19 mJ/cm² by using an air-cooled mercury lamp under the conditions of 25° C. and an oxygen concentration of 100 ppm (parts per million). In this way, the hardcoat layer coating film was semi-cured.

Then, by using a die coater, the semi-cured hardcoat layer coating film was coated with the composition SR-1 for forming an anti-scratch layer so that the film thickness was 0.8 μm after curing.

Thereafter, the obtained laminate was dried at 120° C. for 1 minute and then irradiated with ultraviolet rays at an illuminance of 60 mW/cm², an irradiation dose of 600 mJ/cm², and an oxygen concentration of 100 ppm at 25° C. and further irradiated with ultraviolet rays at an illuminance of 60 mW/cm² and an irradiation dose of 600 mJ/cm² by using an air-cooled mercury lamp under the condition of 100° C. and an oxygen concentration of 100 ppm. In this way, the hardcoat layer coating film and the anti-scratch layer coating film were fully cured, and a hardcoat layer with an anti-scratch layer was formed.

### Comparative Example 61

A hardcoat film of Comparative Example 6 was manufactured in the same manner as in Example 10, except that (r-3) was used as a material of the hardcoat layer instead of the polyorganosilsesquioxane (SQ2-6), the film thickness of the hardcoat layer was changed to 5.8 μm, and the film thickness of the anti-scratch layer was changed to 0.9 μm.

(Tensile Elastic Modulus)

From the manufactured hardcoat film of each of Example 10 and Comparative Example 6 and from the substrate used in the hardcoat film, a sample (test piece) having a width of 10 mm and a length of 120 mm was cut out, and left to stand for 1 hour or more in an environment at a temperature of 25° C. and a relative humidity of 60%. Then, by using TENSILON RTF-1210 (A&D Company, Limited), the sample was pulled under the conditions of a tensile speed of 5 mm/sec and an inter-chuck distance of 100 mm, and the relationship between elongation and load was measured.

From the difference between the load applied in a case where each hardcoat film elongates and the load applied in a case where only the substrate elongates, the load applied only to the hardcoat layer with an anti-scratch layer was calculated.

The elastic modulus (E′_{(0.4)RHC}) of the hardcoat layer with an anti-scratch layer obtained in a case where the elongation rate was 0.4% was determined by the procedures (7), (8), and (9) described above.

The elastic modulus (E′_{(4)RHC}) of the hardcoat layer with an anti-scratch layer obtained in a case where the elongation rate was 4% was determined by the procedures (10), (11), and (12) described above.

The elastic modulus (E′_{(0.4)S}) of the substrate obtained in a case where the elongation rate was 0.4% was calculated by subtracting the stress (load÷cross-sectional area) applied in a case where the elongation rate was 0.2% from the stress (load÷cross-sectional area) applied in a case where the elongation rate was 0.4% (stress difference) and dividing the stress difference by the difference in the elongation rate (0.002).

(Film Thickness of Hardcoat Layer with Anti-Scratch Layer)

The manufactured hardcoat film of each of Example 10 and Comparative Example 6 was cut with a microtome to obtain a cross section, the cross section was observed with a scanning electron microscope (S-4300 manufactured by Hitachi High-Tech Corporation), and the film thickness (d_{RHC}) of the hardcoat layer with an anti-scratch layer was calculated.

(Pencil Hardness)

The hardness of the surface of the hardcoat film on the side of the hardcoat layer with an anti-scratch layer was measured according to JIS K 5600-5-4 (1999).

(Resistance to Repeated Folding)

From the manufactured hardcoat film of each of Example 10 and Comparative Example 6, a sample film having a width of 15 mm and a length of 150 mm was cut out, and left to stand for 1 hour or more in an environment at a temperature of 25° C. and a relative humidity of 60%. Then, by using a 180° folding resistance tester (IMC-0755 manufactured by Imoto Machinery Co., Ltd.), the sample film with the hardcoat layer with an anti-scratch layer facing outwards (the substrate facing inwards) was tested for resistance to repeated folding. In the tester used, the sample film was aligned with the curved surface of a rod (cylinder) having a diameter of 2 mm, folded at the central portion in the longitudinal direction at a bending angle of 180° and then restored to its original condition (the sample film was unfolded). This operation was regarded as a single test, and the test was repeated. The 180° folding test was repeated at 200 times/min. At this time, a sample film in which no crack occurred until the maximum number of times the test was repeated exceeded 300,000 was graded A, a sample film in which no crack occurred until the maximum number of times the test was repeated exceeded 200,000 and reached 300,000 was graded B, a sample film in which no crack occurred until the maximum number of times the test was repeated exceeded 100,000 and reached 200,000 was graded C, a sample film in which no crack occurred until the maximum number of times the test was repeated exceeded 50,000 and reached 100,000 was graded D, and a sample film in which no crack occurred until the maximum number of times the test was repeated reached 50,000 was graded E. Whether or not cracks occur was evaluated using an optical microscope.

(Scratch Resistance)

By using a rubbing tester, a rubbing test was performed on the surface of the anti-scratch layer of the manufactured hardcoat film of each of Example 10 and Comparative Example 6 under the following conditions, thereby obtaining indices of scratch resistance.

Environmental conditions for evaluation: 25° C., relative humidity 60%

Rubbing Material: steel wool (NIHON STEEL WOOL Co., Ltd., grade No. #0000)

The steel wool was wound around the rubbing tip portion (2 cm×2 cm) of the tester coming into contact with the sample and fixed with a band.

Moving distance (one way): 13 cm

Rubbing speed: 13 cm/sec

Load: 1 kg/cm²

Contact area of tip portion: 2 cm×2 cm

Number of times of rubbing: rubbed back and forth 10 times, rubbed back and forth 100 times, rubbed back and forth 1,000 times

After the test, an oil-based black ink was applied to a surface (surface of the substrate) of the hardcoat film that was opposite to the rubbed surface (surface of the anti-scratch layer). The reflected light was visually observed, the number of times of rubbing that caused scratches in the portion contacting the steel wool was counted, and the scratch resistance was evaluated.

A: No scratch occurred even though the sample was rubbed back and forth 1,000 times.

B: No scratch occurred even though the sample was rubbed back and forth 100 times. However, in a case where the sample was rubbed back and forth 1,000 times, scratches occurred.

C: No scratch occurred even though the sample was rubbed back and forth 10 times. However, in a case where the sample was rubbed back and forth 100 times, scratches occurred.

D: Scratches occurred in a case where the sample was rubbed back and forth 10 times.

TABLE 2

| | | | | Physical properties of | | Physical properties | | | |
|---|---|---|---|---|---|---|---|---|---|
| | | Hardcoat layer with | | hardcoat layer with | | of substrate | | | |
| | | anti-scratch layer | | anti-scratch layer | | Elastic modulus | Evaluation | | |
| | | Material | Film | Elastic modulus (MPa) × | | (MPa) × film | | Resistance | |
| | | of | thick- | film thickness (μm) | | thickness (μm) | Pencil | to | |
| | Substrate | hardcoat | ness | At elongation | At elongation | At elongation | hard- | repeated | Scratch |
| | Type | layer | (μm) | rate of 0.4% | rate of 4% | rate of 0.4% | ness | folding | resistance |
| Example 10 | S-1 | (SQ2-6) | 5.5 | 19,684 | 1,484 | 190,970 | 4H | B | A |
| Comparative | S-1 | (r-3) | 6.7 | 11,956 | 9,042 | 190,970 | 4H | D | B |
| Example 6 | | | | | | | | | |

As shown in Table 2, the hardcoat film of Example 10 satisfied E′_{(0.4)RHC}×d_{RHC}≥8,000 MPa·μm and E′_{(4)RHC}×d_{RHC}≤4,000 MPa·μm, and was excellent in all of the hardness, resistance to repeated folding, and scratch resistance. E′_{(0.4)RHC} is an elastic modulus of the hardcoat layer with an anti-scratch layer obtained in a case where the elongation rate is 0.4%. E′_{(4)RHC} is an elastic modulus of the hardcoat layer with an anti-scratch layer obtained in a case where the elongation rate is 4%. d_{RHC} is a film thickness of the hardcoat layer with an anti-scratch layer.

On the other hand, in Comparative Example 6, E′_{(4)RHC}×d_{RHC} was more than 4,000 MPa·μm, and the hardness and resistance to repeated folding were poorer than those in Example 10.

According to an aspect of the present invention, it is possible to provide a hardcoat film which is excellent in hardness and resistance to repeated folding and an article and an image display device which comprise the hardcoat film.

The present invention has been described in detail with reference to specific embodiments. To those skilled in the art, it is obvious that various changes or modifications can be added without departing from the gist and scope of the present invention.

What is claimed is:

1. A hardcoat film comprising:
a substrate; and
a hardcoat layer,
wherein the hardcoat film satisfies the following Formulas (i) and (ii),
E′_{(0.4)HC}×d_{HC}≥8,000 MPa·μm (i)
E′_{(4)HC}×d_{HC}≤4,000 MPa·μm (ii)
E′_{(0.4)HC} is an elastic modulus of the hardcoat layer obtained in a case where an elongation rate is 0.4%,
E′_{(4)HC} is an elastic modulus of the hardcoat layer obtained in a case where an elongation rate is 4%, and
d_{HC} is a film thickness of the hardcoat layer.

2. A hardcoat film comprising:
a substrate; and
a hardcoat layer with an anti-scratch layer,
wherein the hardcoat layer with an anti-scratch layer comprises a hardcoat layer and an anti-scratch layer,
the hardcoat layer is closer to the substrate than the anti-scratch layer,
the hardcoat film satisfies the following Formulas (iii) and (iv),
E′_{(0.4)RHC}×d_{RHC}≥8,000 MPa·μm (iii)
E′_{(4)RHC}×d_{RHC}≤4,000 MPa·μm (iv)
E′_{(0.4)RHC} is an elastic modulus of the hardcoat layer with an anti-scratch layer obtained in a case where an elongation rate is 0.4%,
E′_{(4)RHC} is an elastic modulus of the hardcoat layer with an anti-scratch layer obtained in a case where an elongation rate is 4%, and
d_{RHC} is a film thickness of the hardcoat layer with an anti-scratch layer.

3. The hardcoat film according to claim 1,
wherein the substrate satisfies the following Formula (vi),
100,000 MPa·μm≤E′_{(0.4)S}×d_{S}≤520.000 MPa·μm (vi)
E′_{(0.4)S} is an elastic modulus of the substrate obtained in a case where an elongation rate is 0.4%, and
d_{S} is a film thickness of the substrate.

4. The hardcoat film according to claim 2,
wherein the substrate satisfies the following Formula (vi),
100,000 MPa·μm≤E′_{(0.4)S}×d_{S}≤520,000 MPa·μm (vi)
E′_{(0.4)S} is an elastic modulus of the substrate obtained in a case where an elongation rate is 0.4%, and
d_{S} is a film thickness of the substrate.

5. The hardcoat film according to claim 1,
wherein the hardcoat layer contains a cured product of a composition for forming a hardcoat layer containing a polyorganosilsesquioxane.

6. The hardcoat film according to claim 2,
wherein the hardcoat layer contains a cured product of a composition for forming a hardcoat layer containing a polyorganosilsesquioxane.

7. The hardcoat film according to claim 3,
wherein the hardcoat layer contains a cured product of a composition for forming a hardcoat layer containing a polyorganosilsesquioxane.

8. The hardcoat film according to claim 4,
wherein the hardcoat layer contains a cured product of a composition for forming a hardcoat layer containing a polyorganosilsesquioxane.

9. The hardcoat film according to claim 5,
wherein the polyorganosilsesquioxane contains a constitutional unit (S1) that has a group containing a hydrogen atom capable of forming a hydrogen bond and a constitutional unit (S2) that is different from the constitutional unit (S1) and has a crosslinkable group.

10. The hardcoat film according to claim 6,
wherein the polyorganosilsesquioxane contains a constitutional unit (S1) that has a group containing a hydrogen atom capable of forming a hydrogen bond and a constitutional unit (S2) that is different from the constitutional unit (S1) and has a crosslinkable group.

11. The hardcoat film according to claim 7,
wherein the polyorganosilsesquioxane contains a constitutional unit (S1) that has a group containing a hydrogen atom capable of forming a hydrogen bond and a constitutional unit (S2) that is different from the constitutional unit (S1) and has a crosslinkable group.

12. The hardcoat film according to claim 9,
wherein the group containing a hydrogen atom capable of forming a hydrogen bond that the constitutional unit (S1) has is at least one group selected from an amide group, a urethane group, or a urea group.

13. The hardcoat film according to claim 9,
wherein the constitutional unit (S1) has a (meth)acryloyloxy group or a (meth)acrylamide group.

14. The hardcoat film according to claim 9,
wherein the crosslinkable group that the constitutional unit (S2) has is a (meth)acrylamide group.

15. The hardcoat film according to claim 9,
wherein a weight-average molecular weight of the polyorganosilsesquioxane is 10,000 to 1,000,000.

16. The hardcoat film according to claim 1,
wherein the film thickness of the hardcoat layer is 2 to 14 μm.

17. The hardcoat film according to claim 1,
wherein a film thickness of the substrate is 15 to 80 μm.

18. The hardcoat film according to claim 1,
wherein the substrate contains at least one polymer selected from an imide-based polymer or an aramid-based polymer.

19. An article comprising:
the hardcoat film according to claim 1.

20. An image display device comprising:
the hardcoat film according to claim 1 as a surface protection film.
